(19) United States
(12) Patent Application Publication
(10) Pub. No.: US 2009/0299766 A1
(43) Pub. Date: Dec. 3, 2009

(54) SYSTEM AND METHOD FOR OPTIMIZING MEDICAL TREATMENT PLANNING AND SUPPORT IN DIFFICULT SITUATIONS SUBJECT TO MULTIPLE CONSTRAINTS AND UNCERTAINTIES

(75) Inventors: Robert R. Friedlander, Southbury, CT (US); Richard A. Hennessy, Austin, TX (US); James R. Kraemer, Santa Fe, NM (US); Josko Silobrcic, Swampscott, MA (US)

Correspondence Address: DUKE W. YEE, YEE AND ASSOCIATES, P.C., P.O. BOX 802333, DALLAS, TX, 75380, US

(73) Assignee: International Business Machines Corporation, Armonk, NY (US)

(21) Appl. No.: 12/130,779

(22) Filed: May 30, 2008

(51) Int. Cl. G06Q 50/00

(52) U.S. Cl. 705/3

(57) ABSTRACT

A computer implemented method for managing a condition of a patient during a chaotic event. A datum regarding a first patient is received. A first set of relationships is established. The first set of relationships comprises at least one relationship of the datum to at least one additional datum existing in a database. Based on the first set of relationships, cohorts to which the first patient belongs are established. Ones of the plurality of cohorts contain first data regarding the first patient and second data regarding a set of additional information. The set of additional information is related to the first data. The second data further regards a constraint imposed by a chaotic event. The plurality of cohorts is clustered according to at least one parameter. A cluster of cohorts is formed. Which of at least two cohorts in the cluster are closest to each other is determined.

### BACKGROUND OF THE INVENTION

1. Field of the Invention

The present invention relates generally to selecting control cohorts and more particularly, to a computer implemented method, apparatus, and computer usable program code for automatically selecting a control cohort or for analyzing individual and group healthcare data in order to provide real time healthcare recommendations.

2. Description of the Related Art

A cohort is a group of individuals, machines, components, or modules identified by a set of one or more common characteristics. This group is studied over a period of time as part of a scientific study. A cohort may be studied for medical treatment, engineering, manufacturing, or for any other scientific purpose. A treatment cohort is a cohort selected for a particular action or treatment.

A control cohort is a group selected from a population that is used as the control. The control cohort is observed under ordinary conditions while another group is subjected to the treatment or other factor being studied. The data from the control group is the baseline against which all other experimental results must be measured. For example, a control cohort in a study of medicines for colon cancer may include individuals selected for specified characteristics, such as gender, age, physical condition, or disease state that do not receive the treatment.

The control cohort is used for statistical and analytical purposes. Particularly, the control cohorts are compared with action or treatment cohorts to note differences, developments, reactions, and other specified conditions. Control cohorts are heavily scrutinized by researchers, reviewers, and others that may want to validate or invalidate the viability of a test, treatment, or other research. If a control cohort is not selected according to scientifically accepted principles, an entire research project or study may be considered of no validity wasting large amounts of time and money. In the case of medical research, selection of a less than optimal control cohort may prevent proving the efficacy of a drug or treatment or incorrectly rejecting the efficacy of a drug or treatment. In the first case, billions of dollars of potential revenue may be lost. In the second case, a drug or treatment may be necessarily withdrawn from marketing when it is discovered that the drug or treatment is ineffective or harmful leading to losses in drug development, marketing, and even possible law suits.

Control cohorts are typically manually selected by researchers. Manually selecting a control cohort may be difficult for various reasons. For example, a user selecting the control cohort may introduce bias. Justifying the reasons, attributes, judgment calls, and weighting schemes for selecting the control cohort may be very difficult. Unfortunately, in many cases, the results of difficult and prolonged scientific research and studies may be considered unreliable or unacceptable requiring that the results be ignored or repeated. As a result, manual selection of control cohorts is extremely difficult, expensive, and unreliable.

Additionally, medical care is often difficult in the best of circumstances. Medical care, however, becomes much more difficult during chaotic times, such as during a natural disaster or in the aftermath of a terrorist attack. The problems presented are multidimensional and difficult for even a trained expert to fully grasp in a real time environment. Human-designed solutions are often far less than optimal. If the chaotic event has a large scale, such as a major hurricane or earthquake, then the sheer numbers of cases exponentially increase the problems confronted by medical professionals.

### BRIEF SUMMARY OF THE INVENTION

The illustrative embodiments provide a computer implemented method, apparatus, and computer usable program code for automatically selecting an optimal control cohort. Attributes are selected based on patient data. Treatment cohort records are clustered to form clustered treatment cohorts. Control cohort records are scored to form potential control cohort members. The optimal control cohort is selected by minimizing differences between the potential control cohort members and the clustered treatment cohorts.

The illustrative embodiments also provide for another computer implemented method, computer program product, and data processing system. A datum regarding a first patient is received. A first set of relationships is established. The first set of relationships comprises at least one relationship of the datum to at least one additional datum existing in at least one database. A plurality of cohorts to which the first patient belongs is established based on the first set of relationships. Ones of the plurality of cohorts contain corresponding first data regarding the first patient and corresponding second data regarding a corresponding set of additional information. The corresponding set of additional information is related to the corresponding first data. The corresponding second data further regards a constraint imposed by a chaotic event. The plurality of cohorts is clustered according to at least one parameter, wherein a cluster of cohorts is formed. A determination is made of which of at least two cohorts in the cluster are closest to each other. The at least two cohorts can be stored.

In another illustrative embodiment, a second parameter is optimized, mathematically, against a third parameter. The second parameter is associated with a first one of the at least two cohorts. The third parameter is associated with a second one of the at least two cohorts. A result of optimizing can be stored.

In another illustrative embodiment establishing the plurality of cohorts further comprises establishing to what degree a patient belongs in the plurality of cohorts. In yet another illustrative embodiment the second parameter comprises treatments having a highest probability of success for the patient and the third parameter comprises corresponding costs of the treatments.

In another illustrative embodiment, the second parameter comprises treatments having a lowest probability of negative outcome and the second parameter comprises a highest probability of positive outcome. In yet another illustrative embodiment, the at least one parameter comprises a medical diagnosis, wherein the second parameter comprises false positive diagnoses, and wherein the third parameter comprises false negative diagnoses.

In another illustrative embodiment, the method includes organizing skills data for the chaotic event. Additionally, responsive to receiving an identification of skills and resources required to manage a condition of the patient, a determination is made whether the skills and the resources are available. Then, the skills and the resources are optimized based on requirements and constraints, potential skills, and enabling resources to form optimized skills and optimized resources. Next, The availability of the optimized skills and the optimized resources is verified. Responsive to a determination that the optimized skills and the optimized resources are unavailable, the optimized skills and the optimized resources are re-optimized.

In a yet further illustrative embodiment, this method can further include providing alternative optimized skills and alternative optimized resources in case the optimized skills and the optimized resources are unavailable. Next, the optimized skills and the optimized resources to manage the condition are recommended.

In a yet further illustrative embodiment, there is an absence of all of the optimized skills, the optimized resources, the alternative optimized skills, and the alternative optimized resources. Responsive to this absence, a recommendation is provided to a user regarding how to respond to the condition. The user need not be a medical professional. In this case, the user receives instructions and recommendations appropriate to and understandable by the user.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which an illustrative embodiment may be implemented;

FIG. 2 is a block diagram of a data processing system in which an illustrative embodiment may be implemented;

FIG. 3 is a block diagram of a system for generating control cohorts in accordance with an illustrative embodiment;

FIGS. 4A and 4B are graphical illustrations of clustering in accordance with an illustrative embodiment;

FIG. 5 is a block diagram illustrating information flow for feature selection in accordance with an illustrative embodiment;

FIG. 6 is a block diagram illustrating information flow for clustering records in accordance with an illustrative embodiment;

FIG. 7 is a block diagram illustrating information flow for clustering records for a potential control cohort in accordance with an illustrative embodiment;

FIG. 8 is a block diagram illustrating information flow for generating an optimal control cohort in accordance with an illustrative embodiment;

FIG. 9 is a process for optimal selection of control cohorts in accordance with an illustrative embodiment;

FIG. 10 is a block diagram illustrating an inference engine used for generating an inference not already present in one or more databases being accessed to generate the inference, in accordance with an illustrative embodiment;

FIG. 11 is a flowchart illustrating execution of a query in a database to establish a probability of an inference based on data contained in the database, in accordance with an illustrative embodiment;

FIGS. 12A and 12B are a flowchart illustrating execution of a query in a database to establish a probability of an inference based on data contained in the database, in accordance with an illustrative embodiment;

FIG. 13 is a flowchart execution of an action trigger responsive to the occurrence of one or more factors, in accordance with an illustrative embodiment;

FIG. 14 is a flowchart illustrating an exemplary use of action triggers, in accordance with an illustrative embodiment;

FIG. 15 is a block diagram of a system for providing medical information feedback to medical professionals, in accordance with an illustrative embodiment;

FIG. 16 is a block diagram of a dynamic analytical framework, in accordance with an illustrative embodiment;

FIG. 17 is a flowchart of a process for presenting medical information feedback to medical professionals, in accordance with an illustrative embodiment;

FIG. 18 is a flowchart of a process for presenting medical information feedback to medical professionals, in accordance with an illustrative embodiment;

FIG. 19 is a flowchart of a process for presenting medical information feedback to medical professionals, in accordance with an illustrative embodiment;

FIG. 20 is a flowchart of a process for presenting medical information feedback to medical professionals, in accordance with an illustrative embodiment;

FIG. 21 is a block diagram for managing chaotic events in accordance with the illustrative embodiments;

FIG. 22 is a block diagram for detecting chaotic events in accordance with the illustrative embodiments;

FIG. 23 is a block diagram for predicting severity of chaotic events in accordance with the illustrative embodiments;

FIG. 24 is a block diagram for finding and organizing skills for chaotic events in accordance with the illustrative embodiments;

FIG. 25 is a block diagram for finding and organizing routes for chaotic events in accordance with the illustrative embodiments;

FIG. 26 is a flowchart for managing expert resources during times of chaos in accordance with the illustrative embodiments; and

FIGS. 27A and 27B is a flowchart illustrating a method of managing, during a chaotic event, a condition of a patient, in accordance with the illustrative embodiments.

### DETAILED DESCRIPTION OF THE INVENTION

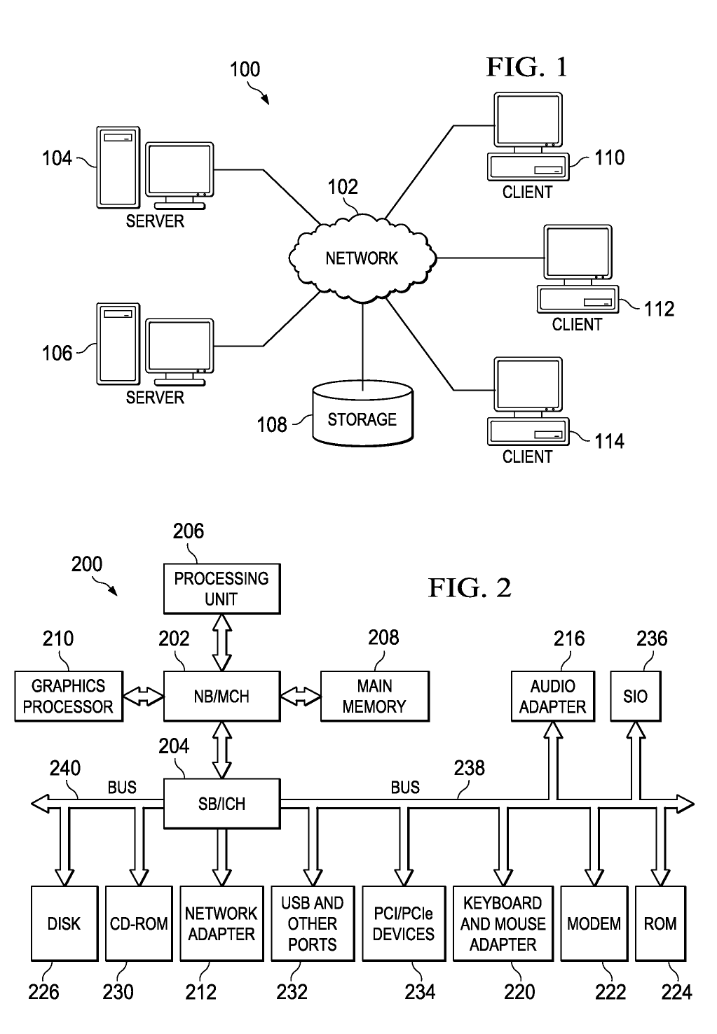

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

With reference now to the figures, FIG. 1 depicts a pictorial representation of a network of data processing systems in which an illustrative embodiment may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

With reference now to FIG. 2, a block diagram of a data processing system is shown in which an illustrative embodiment may be implemented. Data processing system 200 is an example of a computer, such as server 104 or client 110 in FIG. 1, in which computer usable code or instructions implementing the processes may be located for the different embodiments.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) ports and other communications ports 232, and PCI/PCIe devices 234 are coupled to south bridge and I/O controller hub 204 through bus 238, and hard disk drive (HDD) 226 and CD-ROM drive 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206 and coordinates and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java programs or applications executing on data processing system 200 (Java and all Java-based trademarks are trademarks of Sun Microsystems, Inc. in the United States, other countries, or both).

Instructions for the operating system, the object-oriented programming system, and applications or programs are located on storage devices, such as hard disk drive 226, and may be loaded into main memory 208 for execution by processor 206. The processes of the illustrative embodiments may be performed by processor 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

The illustrative embodiments provide a computer implemented method, apparatus, and computer usable program code for optimizing control cohorts. Results of a clustering process are used to calculate an objective function for selecting an optimal control cohort. A cohort is a group of individuals with common characteristics. Frequently, cohorts are used to test the effectiveness of medical treatments. Treatments are processes, medical procedures, drugs, actions, lifestyle changes, or other treatments prescribed for a specified purpose. A control cohort is a group of individuals that share a common characteristic that does not receive the treatment. The control cohort is compared against individuals or other cohorts that received the treatment to statistically prove the efficacy of the treatment.

The illustrative embodiments provide an automated method, apparatus, and computer usable program code for selecting individuals for a control cohort. To demonstrate a cause and effect relationship, an experiment must be designed to show that a phenomenon occurs after a certain treatment is given to a subject and that the phenomenon does not occur in the absence of the treatment. A properly designed experiment generally compares the results obtained from a treatment cohort against a control cohort which is selected to be practically identical. For most treatments, it is often preferable that the same number of individuals is selected for both the treatment cohort and the control cohort for comparative accuracy. The classical example is a drug trial. The cohort or group receiving the drug would be the treatment cohort, and the group receiving the placebo would be the control cohort. The difficulty is in selecting the two cohorts to be as near to identical as possible while not introducing human bias.

The illustrative embodiments provide an automated method, apparatus, and computer usable program code for selecting a control cohort. Because the features in the different embodiments are automated, the results are repeatable and introduce minimum human bias. The results are independently verifiable and repeatable in order to scientifically certify treatment results.

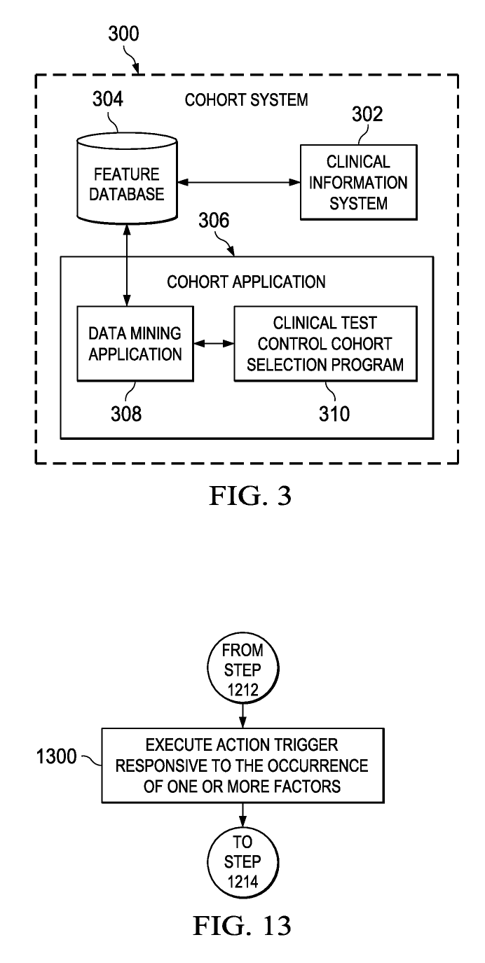

FIG. 3 is a block diagram of a system for generating control cohorts in accordance with an illustrative embodiment. Cohort system 300 is a system for generating control cohorts. Cohort system 300 includes clinical information system (CIS) 302, feature database 304, and cohort application 306. Each component of cohort system 300 may be interconnected via a network, such as network 102 of FIG. 1. Cohort application 306 further includes data mining application 308 and clinical test control cohort selection program 310.

Clinical information system 302 is a management system for managing patient data. This data may include, for example, demographic data, family health history data, vital signs, laboratory test results, drug treatment history, admission-discharge-treatment (ADT) records, co-morbidities, modality images, genetic data, and other patient data. Clinical information system 302 may be executed by a computing device, such as server 104 or client 110 of FIG. 1. Clinical information system 302 may also include information about population of patients as a whole. Such information may disclose patients who have agreed to participate in medical research but who are not participants in a current study. Clinical information system 302 includes medical records for acquisition, storage, manipulation, and distribution of clinical information for individuals and organizations. Clinical information system 302 is scalable, allowing information to expand as needed. Clinical information system 302 may also include information sourced from pre-existing systems, such as pharmacy management systems, laboratory management systems, and radiology management systems.

Feature database 304 is a database in a storage device, such as storage 108 of FIG. 1. Feature database 304 is populated with data from clinical information system 302. Feature database 304 includes patient data in the form of attributes. Attributes define features, variables, and characteristics of each patient. The most common attributes may include gender, age, disease or illness, and state of the disease.

Cohort application 306 is a program for selecting control cohorts. Cohort application 306 is executed by a computing device, such as server 104 or client 110 of FIG. 1. Data mining application 308 is a program that provides data mining functionality on feature database 304 and other interconnected databases. In one example, data mining application 308 may be a program, such as DB2 Intelligent Miner produced by International Business Machines Corporation. Data mining is the process of automatically searching large volumes of data for patterns. Data mining may be further defined as the nontrivial extraction of implicit, previously unknown, and potentially useful information from data. Data mining application 308 uses computational techniques from statistics, information theory, machine learning, and pattern recognition.

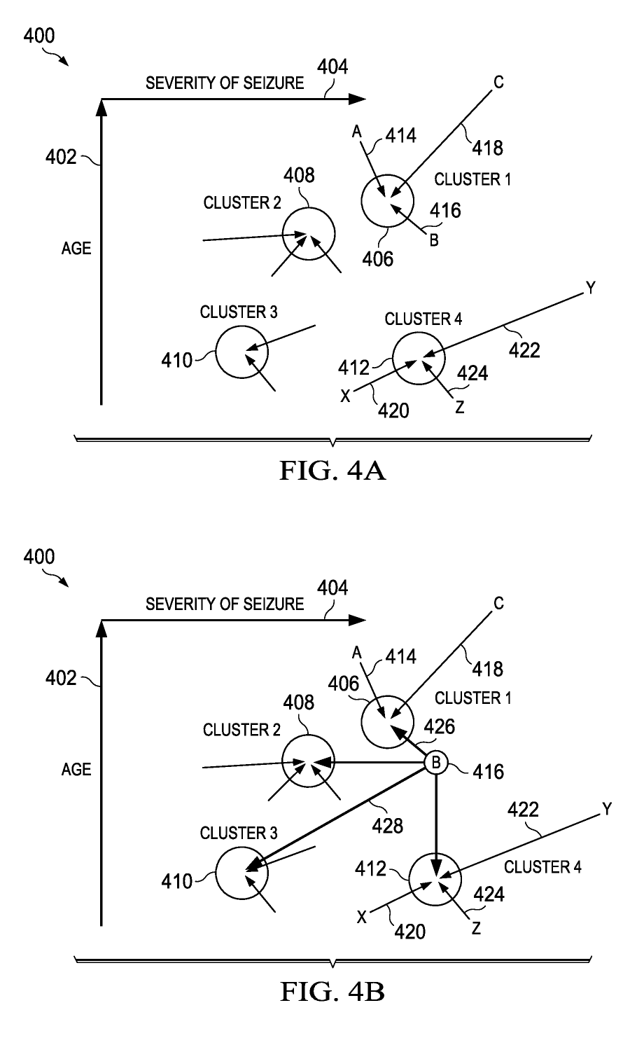

Particularly, data mining application 308 extracts useful information from feature database 304. Data mining application 308 allows users to select data, analyze data, show patterns, sort data, determine relationships, and generate statistics. Data mining application 308 may be used to cluster records in feature database 304 based on similar attributes. Data mining application 308 searches the records for attributes that most frequently occur in common and groups the related records or members accordingly for display or analysis to the user. This grouping process is referred to as clustering. The results of clustering show the number of detected clusters and the attributes that make up each cluster. Clustering is further described with respect to FIGS. 4A-4B.

For example, data mining application 308 may be able to group patient records to show the effect of a new sepsis blood infection medicine. Currently, about 35 percent of all patients with the diagnosis of sepsis die. Patients entering an emergency department of a hospital who receive a diagnosis of sepsis, and who are not responding to classical treatments, may be recruited to participate in a drug trial. A statistical control cohort of similarly ill patients could be developed by cohort system 300, using records from historical patients, patients from another similar hospital, and patients who choose not to participate. Potential features to produce a clustering model could include age, co-morbidities, gender, surgical procedures, number of days of current hospitalization, O2 blood saturation, blood pH, blood lactose levels, bilirubin levels, blood pressure, respiration, mental acuity tests, and urine output.

Data mining application 308 may use a clustering technique or model known as a Kohonen feature map neural network or neural clustering. Kohonen feature maps specify a number of clusters and the maximum number of passes through the data. The number of clusters must be between one and the number of records in the treatment cohort. The greater the number of clusters, the better the comparisons can be made between the treatment and the control cohort. Clusters are natural groupings of patient records based on the specified features or attributes. For example, a user may request that data mining application 308 generate eight clusters in a maximum of ten passes. The main task of neural clustering is to find a center for each cluster. The center is also called the cluster prototype. Scores are generated based on the distance between each patient record and each of the cluster prototypes. Scores closer to zero have a higher degree of similarity to the cluster prototype. The higher the score, the more dissimilar the record is from the cluster prototype.

All inputs to a Kohonen feature map must be scaled from 0.0 to 1.0. In addition, categorical values must be converted into numeric codes for presentation to the neural network. Conversions may be made by methods that retain the ordinal order of the input data, such as discrete step functions or bucketing of values. Each record is assigned to a single cluster, but by using data mining application 308, a user may determine a record's Euclidean dimensional distance for all cluster prototypes. Clustering is performed for the treatment cohort. Clinical test control cohort selection program 310 minimizes the sum of the Euclidean distances between the individuals or members in the treatment cohorts and the control cohort. Clinical test control cohort selection program 310 may incorporate an integer programming model, such as integer programming system 806 of FIG. 8. This program may be programmed in International Business Machine Corporation products, such as Mathematical Programming System eXtended (MPSX), the IBM Optimization Subroutine Library, or the open source GNU Linear Programming Kit. The illustrative embodiments minimize the summation of all records/cluster prototype Euclidean distances from the potential control cohort members to select the optimum control cohort.

FIGS. 4A-4B are graphical illustrations of clustering in accordance with an illustrative embodiment. Feature map 400 of FIG. 4A is a self-organizing map (SOM) and is a subtype of artificial neural networks. Feature map 400 is trained using unsupervised learning to produce low-dimensional representation of the training samples while preserving the topological properties of the input space. This makes feature map 400 especially useful for visualizing high-dimensional data, including cohorts and clusters.

In one illustrative embodiment, feature map 400 is a Kohonen Feature Map neural network. Feature map 400 uses a process called self-organization to group similar patient records together. Feature map 400 may use various dimensions. In this example, feature map 400 is a two-dimensional feature map including age 402 and severity of seizure 404. Feature map 400 may include as many dimensions as there are features, such as age, gender, and severity of illness. Feature map 400 also includes cluster 1 406, cluster 2 408, cluster 3 410, and cluster 4 412. The clusters are the result of using feature map 400 to group individual patients based on the features. The clusters are self-grouped local estimates of all data or patients being analyzed based on competitive learning. When a training sample of patients is analyzed by data mining application 308 of FIG. 3, each patient is grouped into clusters where the clusters are weighted functions that best represent natural divisions of all patients based on the specified features.

The user may choose to specify the number of clusters and the maximum number of passes through the data. These parameters control the processing time and the degree of granularity used when patient records are assigned to clusters. The primary task of neural clustering is to find a center for each cluster. The center is called the cluster prototype. For each record in the input patient data set, the neural clustering data mining algorithm computes the cluster prototype that is the closest to the records. For example, patient record A 414, patient record B 416, and patient record C 418 are grouped into cluster 1 406. Additionally, patient record X 420, patient record Y 422, and patient record Z 424 are grouped into cluster 4 412.

FIG. 4B further illustrates how the score for each data record is represented by the Euclidean distance from the cluster prototype. The higher the score, the more dissimilar the record is from the particular cluster prototype. With each pass over the input patient data, the centers are adjusted so that a better quality of the overall clustering model is reached. To score a potential control cohort for each patient record, the Euclidian distance is calculated from each cluster prototype. This score is passed along to an integer programming system in clinical test control cohort selection program 310 of FIG. 3. The scoring of each record is further shown by integer programming system 806 of FIG. 8 below.

For example, patient B 416 is scored into the cluster prototype or center of cluster 1 406, cluster 2 408, cluster 3 410 and cluster 4 412. A Euclidean distance between patient B 416 and cluster 1 406, cluster 2 408, cluster 3 410 and cluster 4 412 is shown. In this example, distance 1 426, separating patient B 416 from cluster 1 406, is the closest. Distance 3 428, separating patient B 416 from cluster 3 410, is the furthest. These distances indicate that cluster 1 406 is the best fit.

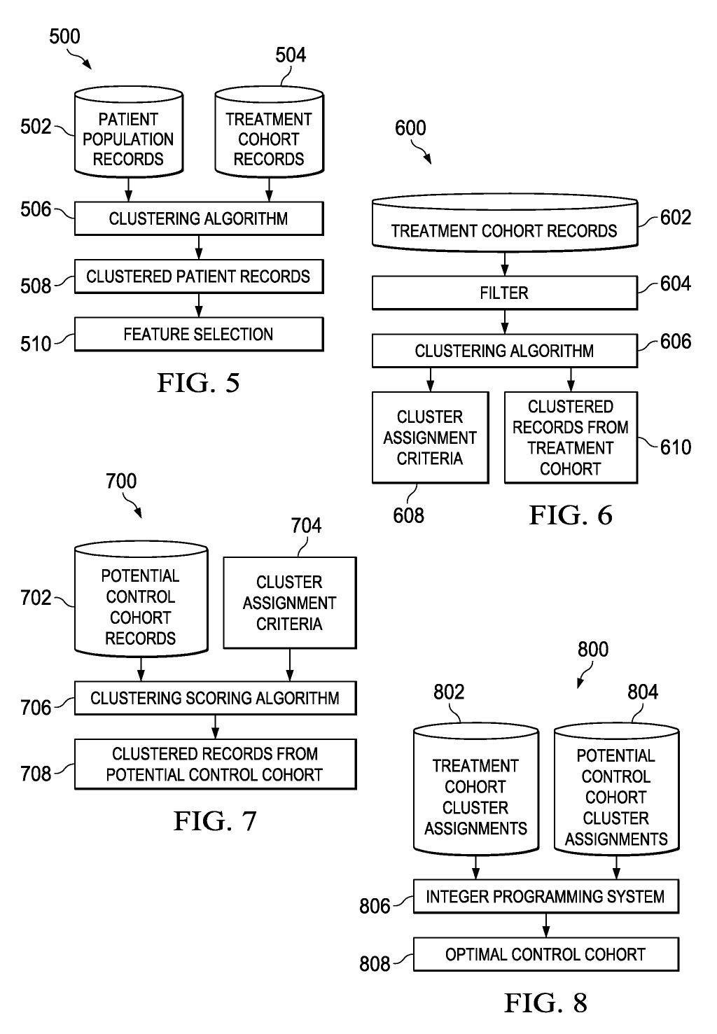

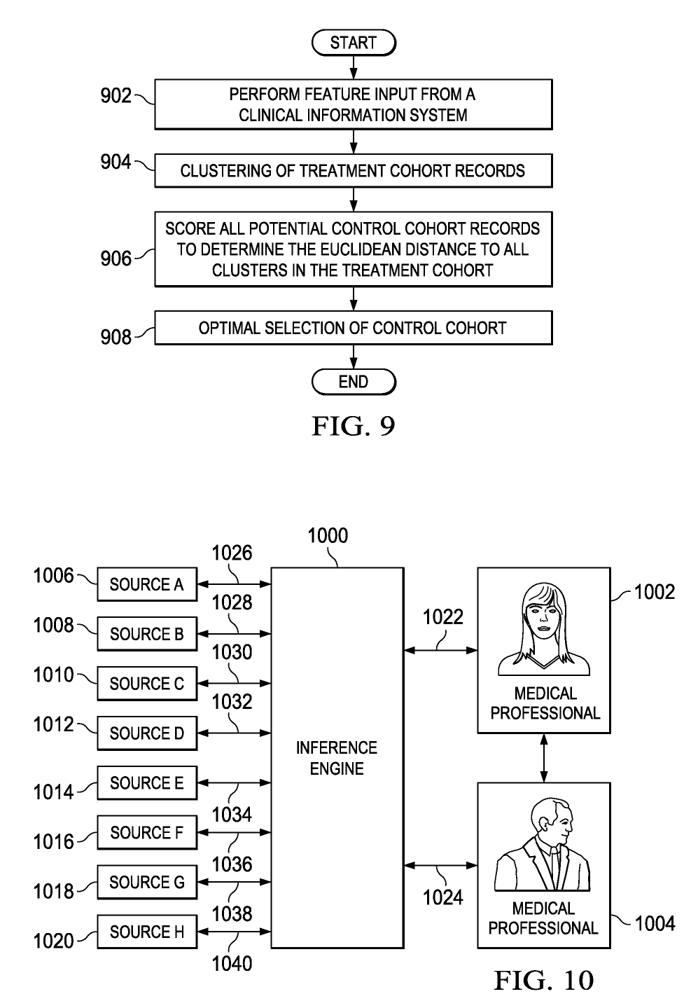

FIG. 5 is a block diagram illustrating information flow for feature selection in accordance with an illustrative embodiment. The block diagram of FIG. 5 may be implemented in cohort application 306 of FIG. 3. Feature selection system 500 includes various components and modules used to perform variable selection. The features selected are the features or variables that have the strongest effect in cluster assignment. For example, blood pressure and respiration may be more important in cluster assignment than patient gender. Feature selection system 500 may be used to perform step 902 of FIG. 9. Feature selection system 500 includes patient population records 502, treatment cohort records 504, clustering algorithm 506, clustered patient records 508, and produces feature selection 510.

Patient population records 502 are all records for patients who are potential control cohort members. Patient population records 502 and treatment cohort records 504 may be stored in a database or system, such as clinical information system 302 of FIG. 3. Treatment cohort records 504 are all records for the selected treatment cohort. The treatment cohort is selected based on the research, study, or other test that is being performed.

Clustering algorithm 506 uses the features from treatment cohort records 504 to group patient population records in order to form clustered patient records 508. Clustered patient records 508 include all patients grouped according to features of treatment cohort records 504. For example, clustered patient records 508 may be clustered by a clustering algorithm according to gender, age, physical condition, genetics, disease, disease state, or any other quantifiable, identifiable, or other measurable attribute. Clustered patient records 508 are clustered using feature selection 510.

Feature selection 510 is the features and variables that are most important for a control cohort to mirror the treatment cohort. For example, based on the treatment cohort, the variables in feature selection 510 most important to match in the treatment cohort may be age 402 and severity of seizure 404 as shown in FIG. 4.

FIG. 6 is a block diagram illustrating information flow for clustering records in accordance with an illustrative embodiment. The block diagram of FIG. 6 may be implemented in cohort application 306 of FIG. 3. Cluster system 600 includes various components and modules used to cluster assignment criteria and records from the treatment cohort. Cluster system 600 may be used to perform step 904 of FIG. 9. Cluster system 600 includes treatment cohort records 602, filter 604, clustering algorithm 606, cluster assignment criteria 608, and clustered records from treatment cohort 610. Filter 604 is used to eliminate any patient records that have significant co-morbidities that would by itself eliminate inclusion in a drug trial. Co-morbidities are other diseases, illnesses, or conditions in addition to the desired features. For example, it may be desirable to exclude results from persons with more than one stroke from the statistical analysis of a new heart drug.

Treatment cohort records 602 are the same as treatment cohort records 504 of FIG. 5. Filter 604 filters treatment cohort records 602 to include only selected variables such as those selected by feature selection 510 of FIG. 5.

Clustering algorithm 606 is similar to clustering algorithm 506 of FIG. 5. Clustering algorithm 606 uses the results from filter 604 to generate cluster assignment criteria 608 and clustered records from treatment cohort 610. For example, patient A 414, patient B 416, and patient C 418 are assigned into cluster 1 406, all of FIGS. 4A-4B. Clustered records from treatment cohort 610 are the records for patients in the treatment cohort. Every patient is assigned to a primary cluster, and a Euclidean distance to all other clusters is determined. The distance is a distance, such as distance 426, separating patient B 416 and the center or cluster prototype of cluster 1 406 of FIG. 4B. In FIG. 4B, patient B 416 is grouped into the primary cluster of cluster 1 406 because of proximity. Distances to cluster 2 408, cluster 3 410, and cluster 4 412 are also determined.

FIG. 7 is a block diagram illustrating information flow for clustering records for a potential control cohort in accordance with an illustrative embodiment. The block diagram of FIG. 7 may be implemented in cohort application 306 of FIG. 3. Cluster system 700 includes various components and modules used to cluster potential control cohorts. Cluster system 700 may be used to perform step 906 of FIG. 9. Cluster system 700 includes potential control cohort records 702, cluster assignment criteria 704, clustering scoring algorithm 706, and clustered records from potential control cohort 708.

Potential control cohort records 702 are the records from patient population records, such as patient population records 502 of FIG. 5 that may be selected to be part of the control cohort. For example, potential control cohort records 702 do not include patient records from the treatment cohort. Clustering scoring algorithm 706 uses cluster assignment criteria 704 to generate clustered records from potential control cohort 708. Cluster assignment criteria are the same as cluster assignment criteria 608 of FIG. 6.

FIG. 8 is a block diagram illustrating information flow for generating an optimal control cohort in accordance with an illustrative embodiment. Cluster system 800 includes various components and modules used to cluster the optimal control cohort. Cluster system 800 may be used to perform step 908 of FIG. 9. Cluster system 800 includes treatment cohort cluster assignments 802, potential control cohort cluster assignments 804, integer programming system 806, and optimal control cohort 808. The cluster assignments indicate the treatment and potential control cohort records that have been grouped to that cluster.

0-1 Integer programming is a special case of integer programming where variables are required to be 0 or 1, rather than some arbitrary integer. The illustrative embodiments use integer programming system 806 because a patient is either in the control group or is not in the control group. Integer programming system 806 selects the optimum patients for optimal control cohort 808 that minimize the differences from the treatment cohort. The objective function of integer programming system 806 is to minimize the absolute value of the sum of the Euclidian distance of all possible control cohorts compared to the treatment cohort cluster prototypes. 0-1 Integer programming typically utilizes many well-known techniques to arrive at the optimum solution in far less time than would be required by complete enumeration. Patient records may be used zero or one time in the control cohort. Optimal control cohort 808 may be displayed in a graphical format to demonstrate the rank and contribution of each feature/variable for each patient in the control cohort.

FIG. 9 is a flowchart of a process for optimal selection of control cohorts in accordance with an illustrative embodiment. The process of FIG. 9 may be implemented in cohort system 300 of FIG. 3. The process first performs feature input from a clinical information system (step 902). In step 902, the process step moves every potential patient feature data stored in a clinical data warehouse, such as clinical information system 302 of FIG. 3. During step 902, many more variables are input than will be used by the clustering algorithm. These extra variables will be discarded by feature selection 510 of FIG. 5.

Some variables, such as age and gender, will need to be included in all clustering models. Other variables are specific to given diseases like Gleason grading system to help describe the appearance of the cancerous prostate tissue. Most major diseases have similar scales measuring the severity and spread of a disease. In addition to variables describing the major disease focus of the disease, most patients have co-morbidities. These might be conditions like diabetes, high blood pressure, stroke, or other forms of cancer. These comormidities may skew the statistical analysis so the control cohort must carefully select patients who well mirror the treatment cohort.

Next, the process clusters treatment cohort records (step 904). Next, the process scores all potential control cohort records to determine the Euclidean distance to all clusters in the treatment cohort (step 906). Step 904 and 906 may be performed by data mining application 308 based on data from feature database 304 and clinical information system 302 all of FIG. 3. Next, the process performs optimal selection of a control cohort (step 908) with the process terminating thereafter. Step 908 may be performed by clinical test control cohort selection program 310 of FIG. 3. The optimal selection is made based on the score calculated during step 906. The scoring may also involving weighting. For example, if a record is an equal distance between two clusters, but one cluster has more records the record may be clustered in the cluster with more records. During step 908, names, unique identifiers, or encoded indices of individuals in the optimal control cohort are displayed or otherwise provided.

In one illustrative scenario, a new protocol has been developed to reduce the risk of re-occurrence of congestive heart failure after discharging a patient from the hospital. A pilot program is created with a budget sufficient to allow 600 patients in the treatment and control cohorts. The pilot program is designed to apply the new protocol to a treatment cohort of patients at the highest risk of re-occurrence.

The clinical selection criteria for inclusion in the treatment cohort specifies that each individual:
1. Have more than one congestive heart failure related admission during the past year.
2. Have fewer than 60 days since the last congestive heart failure related admission.
3. Be 45 years or older.

Each of these attributes may be determined during feature selection of step 902. The clinical criteria yields 296 patients for the treatment cohort, so 296 patients are needed for the control cohort. The treatment cohort and control cohort are selected from patient records stored in feature database 304 or clinical information system 302 of FIG. 3.

Originally, there were 2,927 patients available for the study. The treatment cohort reduces the patient number to 2,631 unselected patients. Next, the 296 patients of the treatment cohort are clustered during step 904. The clustering model determined during step 904 is applied to the 2,631 unselected patients to score potential control cohort records in step 906. Next, the process selects the best matching 296 patients for the optimal selection of a control cohort in step 908. The result is a group of 592 patients divided between treatment and control cohorts who best fit the clinical criteria. The results of the control cohort selection are repeatable and defendable.

Thus, the illustrative embodiments provide a computer implemented method, apparatus, and computer usable program code for optimizing control cohorts. The control cohort is automatically selected from patient records to minimize the differences between the treatment cohort and the control cohort. The results are automatic and repeatable with the introduction of minimum human bias.

### ADDITIONAL ILLUSTRATIVE EMBODIMENTS

The illustrative embodiments also provide for a computer implemented method, apparatus, and computer usable program code for automatically selecting an optimal control cohort. Attributes are selected based on patient data. Treatment cohort records are clustered to form clustered treatment cohorts. Control cohort records are scored to form potential control cohort members. The optimal control cohort is selected by minimizing differences between the potential control cohort members and the clustered treatment cohorts.

The illustrative embodiments provide for a computer implemented method for automatically selecting an optimal control cohort, the computer implemented method comprising: selecting attributes based on patient data; clustering of treatment cohort records to form clustered treatment cohorts; scoring control cohort records to form potential control cohort members; and selecting the optimal control cohort by minimizing differences between the potential control cohorts members and the clustered treatment cohorts.

In this illustrative example, the patient data can be stored in a clinical database. The attributes can be any of features, variables, and characteristics. The clustered treatment cohorts can show a number of clusters and characteristics of each of the number of clusters. The attributes can include gender, age, disease state, genetics, and physical condition. Each patient record can be scored to calculate the Euclidean distance to all clusters. A user can specify the number of clusters for the clustered treatment cohorts and a number of search passes through the patient data to generate the number of clusters. The selecting attributes and the clustering steps can be performed by a data mining application, wherein the selecting the optimal control cohort step is performed by a 0-1 integer programming model.

In another illustrative embodiment, the selecting step further can further comprise: searching the patient data to determine the attributes that most strongly differentiate assignment of patient records to particular clusters. In another illustrative embodiment the scoring step comprises: scoring all patient records by computing a Euclidean distance to cluster prototypes of all treatment cohorts. In another illustrative embodiment the clustering step further comprises: generating a feature map to form the clustered treatment cohorts.

In another illustrative embodiment, any of the above methods can include providing names, unique identifiers, or encoded indices of individuals in the optimal control cohort. In another illustrative embodiment, the feature map is a Kohonen feature map.

The illustrative embodiments also provide for an optimal control cohort selection system comprising: an attribute database operatively connected to a clinical information system for storing patient records including attributes of patients; a server operably connected to the attribute database wherein the server executes a data mining application and a clinical control cohort selection program wherein the data mining application selects specified attributes based on patient data, clusters treatment cohort records based on the specified attributes to form clustered treatment cohorts, and clusters control cohort records based on the specified attributes to form clustered control cohorts; and wherein the clinical control cohort selection program selects the optimal control cohort by minimizing differences between the clustered control cohorts and the clustered treatment cohorts.

In this illustrative embodiment, the clinical information system includes information about populations of patients wherein the information is accessed by the server. In another illustrative embodiment, the data mining application is IBM DB2 Intelligent Miner.

The illustrative embodiments also provide for a computer program product comprising a computer usable medium including computer usable program code for automatically selecting an optimal control cohort, the computer program product comprising: computer usable program code for selecting attributes based on patient data; computer usable program code for clustering of treatment cohort records to form clustered treatment cohorts; computer usable program code for scoring control cohort records to form potential control cohort members; and computer usable program code for selecting the optimal control cohort by minimizing differences between the potential control cohorts members and the clustered treatment cohorts.

In this illustrative embodiment, the computer program product can also include computer usable program code for scoring all patient records in a self organizing map by computing a Euclidean distance to cluster prototypes of all treatment cohorts; and computer usable program code for generating a feature map to form the clustered treatment cohorts. In another illustrative embodiment, the computer program product can also include computer usable program code for specifying a number of clusters for the clustered treatment cohorts and a number of search passes through the patient data to generate the number of clusters. In yet another illustrative embodiment, the computer usable program code for selecting further comprises: computer usable program code for searching the patient data to determine the attributes that most strongly differentiate assignment of patient records to particular clusters.

Returning to the figures, FIG. 10 is a block diagram illustrating an inference engine used for generating an inference not already present in one or more databases being accessed to generate the inference, in accordance with an illustrative embodiment. The method shown in FIG. 10 can be implemented by one or more users using one or more data processing systems, such as server 104, server 106, client 110, client 112, and client 114 in FIG. 1 and data processing system 200 shown in FIG. 2, which communicate over a network, such as network 102 shown in FIG. 1. Additionally, the illustrative embodiments described in FIG. 10 and throughout the specification can be implemented using these data processing systems in conjunction with inference engine 1000. Inference engine 1000 has been developed during our past work, including our previously filed and published patent applications.

FIG. 10 shows a solution to the problem of allowing different medical professionals to both find and consider relevant information from a truly massive amount of divergent data. Inference engine 1000 allows medical professional 1002 and medical professional 1004 to find relevant information based on one or more queries and, more importantly, cause inference engine 1000 to assign probabilities to the likelihood that certain inferences can be made based on the query. The process is massively recursive in that every piece of information added to the inference engine can cause the process to be re-executed. An entirely different result can arise based on new information. Information can include the fact that the query itself was simply made. Information can also include the results of the query, or information can include data from any one of a number of sources.

Additionally, inference engine 1000 receives as much information as possible from as many different sources as possible. Thus, inference engine 1000 serves as a central repository of information from medical professional 1002, medical professional 1004, source A 1006, source B 1008, source C 1010, source D 1012, source E 1014, source F 1016, source G 1018, and source H 1020. In an illustrative embodiment, inference engine 1000 can also input data into each of those sources. Arrows 1022, arrows 1024, arrows 1026, arrows 1028, arrows 1030, arrows 1032, arrows 1034, arrows 1036, arrows 1038, and arrows 1040 are all bidirectional arrows to indicate that inference engine 1000 is capable of both receiving and inputting information from and to all sources of information. However, not all sources are necessarily capable of receiving data; in these cases, inference engine 1000 does not attempt to input data into the corresponding source.

In an illustrative example relating to generating an inference relating to the provision of healthcare, either or both of medical professional 1002 or medical professional 1004 are attempting to diagnose a patient having symptoms that do not exactly match any known disease or medical condition. Either or both of medical professional 1002 or medical professional 1004 can submit queries to inference engine 1000 to aid in the diagnosis. The queries are based on symptoms that the patient is exhibiting, and possibly also based on guesses and information known to the doctors. Inference engine 1000 can access numerous databases, such as any of sources A through H, and can even take into account that both medical professional 1002 and medical professional 1004 are both making similar queries, all in order to generate a probability of an inference that the patient suffers from a particular medical condition, a set of medical conditions, or even a new (emerging) medical condition. Inference engine 1000 greatly increases the odds that a correct diagnosis will be made by eliminating or reducing incorrect diagnoses.

Thus, inference engine 1000 is adapted to receive a query regarding a fact, use the query as a frame of reference, use a set of rules to generate a second set of rules to be applied when executing the query, and then execute the query using the second set of rules to compare data in inference engine 1000 to create probability of an inference. The probability of the inference is stored as additional data in the database and is reported to the medical professional or medical professionals submitting the query. Inference engine 1000 can prompt one or both of medical professional 1002 and medical professional 1004 to contact each other for possible consultation.

Thus, continuing the above example, medical professional 1002 submits a query to inference engine 1000 to generate probabilities that a patient has a particular condition or set of conditions. Inference engine 1000 uses these facts or concepts as a frame of reference. A frame of reference is an anchor datum or set of data that is used to limit which data are searched in inference engine 1000. The frame of reference also helps define the search space. The frame of reference also is used to determine to what rules the searched data will be subject. Thus, when the query is executed, sufficient processing power will be available to make inferences.

The frame of reference is used to establish a set of rules for generating a second set of rules. For example, the set of rules could be used to generate a second set of rules that include searching all information related to the enumerated symptoms, all information related to similar symptoms, and all information related to medical experts known to specialize in conditions possibly related to the enumerated symptoms, but (in this example only) no other information. The first set of rules also creates a rule that specifies that only certain interrelationships between these data sets will be searched.

Inference engine 1000 uses the second set of rules when the query is executed. In this case, the query compares the relevant data in the described classes of information. In comparing the data from all sources, the query matches symptoms to known medical conditions. Inference engine 1000 then produces a probability of an inference. The inference, in this example, is that the patient suffers from both Parkinson's disease and Alzheimer's disease, but also may be exhibiting a new medical condition. Possibly thousands of other inferences matching other medical conditions are also made; however, only the medical conditions above a defined (by the user or by inference engine 1000 itself) probability are presented. In this case, the medical professional desires to narrow the search because the medical professional cannot pick out the information regarding the possible new condition from the thousands of other inferences.

Continuing the example, the above inference and the probability of inference are re-inputted into inference engine 1000 and an additional query is submitted to determine an inference regarding a probability of a new diagnosis. Again, inference engine 1000 establishes the facts of the query as a frame of reference and then uses a set of rules to determine another set of rules to be applied when executing the query. This time, the query will compare disease states identified in the first query. The query will also compare new information or databases relating to those specific diseases.

The query is again executed using the second set of rules. The query compares all of the facts and creates a probability of a second inference. In this illustrative example, the probability of a second inference is a high chance that, based on the new search, the patient actually has Alzheimer's disease and another, known, neurological disorder that better matches the symptoms. Medical professional 1002 then uses this inference to design a treatment plan for the patient.

Inference engine 1000 includes one or more divergent data. The plurality of divergent data includes a plurality of cohort data. Each datum of the database is conformed to the dimensions of the database. Each datum of the plurality of data has associated metadata and an associated key. A key uniquely identifies an individual datum. A key can be any unique identifier, such as a series of numbers, alphanumeric characters, other characters, or other methods of uniquely identifying objects. The associated metadata includes data regarding cohorts associated with the corresponding datum, data regarding hierarchies associated with the corresponding datum, data regarding a corresponding source of the datum, and data regarding probabilities associated with integrity, reliability, and importance of each associated datum.

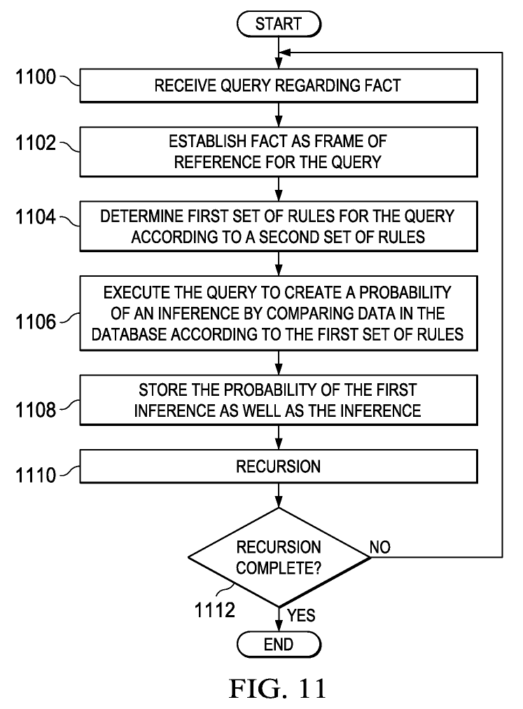

FIG. 11 is a flowchart illustrating execution of a query in a database to establish a probability of an inference based on data contained in the database, in accordance with an illustrative embodiment. The process shown in FIG. 11 can be implemented using inference engine 1000 and can be implemented in a single data processing system or across multiple data processing systems connected by one or more networks. Whether implemented in a single data processing system or across multiple data processing systems, taken together all data processing systems, hardware, software, and networks are together referred to as a system. The system implements the process.

The process begins as the system receives a query regarding a fact (step 1100). The system establishes the fact as a frame of reference for the query (step 1102). The system then determines a first set of rules for the query according to a second set of rules (step 1104). The system executes the query according to the first set of rules to create a probability of an inference by comparing data in the database (step 1106). The system then stores the probability of the first inference and also stores the inference (step 1108).

The system then performs a recursion process (step 1110). During the recursion process steps 1100 through 1108 are repeated again and again, as each new inference and each new probability becomes a new fact that can be used to generate a new probability and a new inference. Additionally, new facts can be received in central database 400 during this process, and those new facts also influence the resulting process. Each conclusion or inference generated during the recursion process can be presented to a user, or only the final conclusion or inference made after step 1112 can be presented to a user, or a number of conclusions made prior to step 1112 can be presented to a user.

The system then determines whether the recursion process is complete (step 1112). If recursion is not complete, the process between steps 1100 and 1110 continues. If recursion is complete, the process terminates.

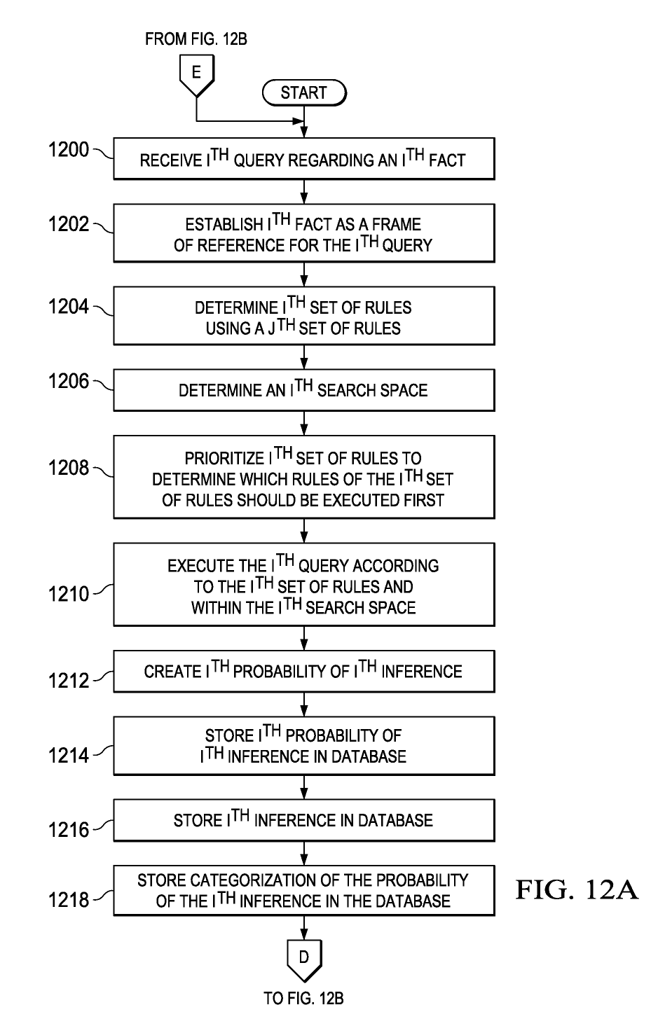

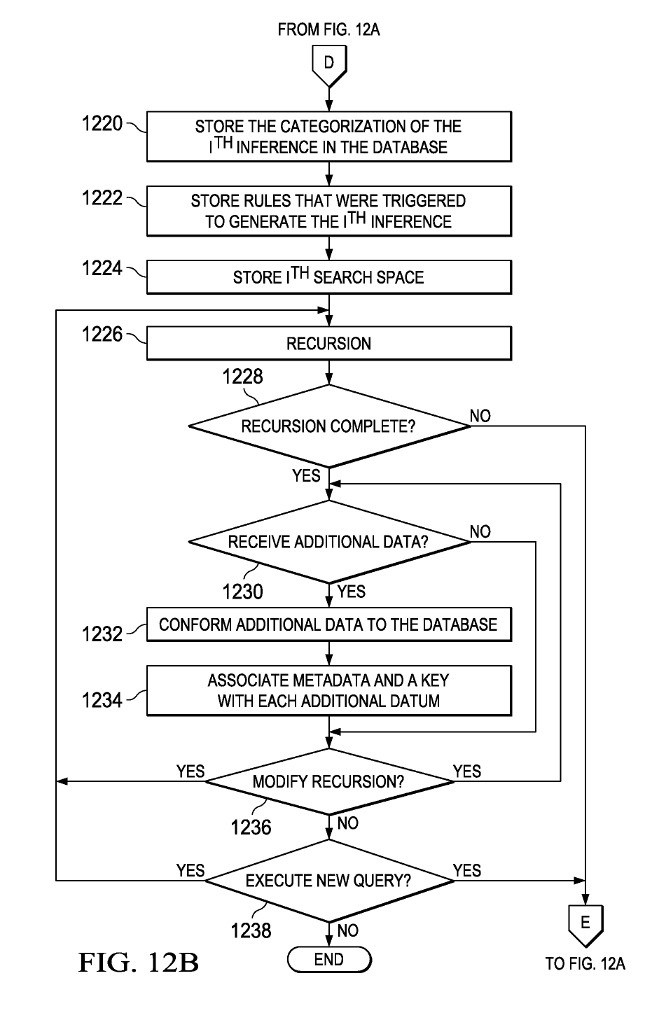

FIGS. 12A and 12B are a flowchart illustrating execution of a query in a database to establish a probability of an inference based on data contained in the database, in accordance with an illustrative embodiment. The process shown in FIGS. 12A and 12B can be implemented using inference engine 1000 and can be implemented in a single data processing system or across multiple data processing systems connected by one or more networks. Whether implemented in a single data processing system or across multiple data processing systems, taken together all data processing systems, hardware, software, and networks are together referred to as a system. The system implements the process.

The process begins as the system receives an I^{th} query regarding an I^{th} fact (step 1200). The term “I^{th}” refers to an integer, beginning with one. The integer reflects how many times a recursion process, referred to below, has been conducted. Thus, for example, when a query is first submitted that query is the 1^{st} query. The first recursion is the 2^{nd} query. The second recursion is the 3^{rd} query, and so forth until recursion I-1 forms the “I^{th}” query. Similarly, but not the same, the I^{th} fact is the fact associated with the I^{th} query. Thus, the 1^{st} fact is associated with the 1^{st} query, the 2^{nd} fact is associated with the 2^{nd} query, etc. The I^{th} fact can be the same as previous facts, such as the I^{th}-1 fact, the I^{th}-2 fact, etc. The I^{th} fact can be a compound fact. A compound fact is a fact that includes multiple sub-facts. The I^{th} fact can start as a single fact and become a compound fact on subsequent recursions or iterations. The I^{th} fact is likely to become a compound fact during recursion, as additional information is added to the central database during each recursion.

After receiving the I^{th} query, the system establishes the I^{th} fact as a frame of reference for the I^{th} query (step 1202). A frame of reference is an anchor datum or set of data that is used to limit which data are searched in central database 400, that is defines the search space. The frame of reference also is used to determine to what rules the searched data will be subject. Thus, when the query is executed, sufficient processing power will be available to make inferences.

The system then determines an I^{th} set of rules using a J^{th} set of rules (step 1204). In other words, a different set of rules is used to determine the set of rules that are actually applied to the I^{th} query. The term “Jₜₕ” refers to an integer, starting with one, wherein J=1 is the first iteration of the recursion process and I-1 is the J^{th} iteration of the recursion process. The J^{th} set of rules may or may not change from the previous set, such that J^{th}-1 set of rules may or may not be the same as the J^{th} set of rules. The term “J^{th}” set of rules refers to the set of rules that establishes the search rules, which are the I^{th} set of rules. The J^{th} set of rules is used to determine the I^{th} set of rules.

The system then determines an I^{th} search space (step 1206). The I^{th} search space is the search space for the I^{th} iteration. A search space is the portion of a database, or a subset of data within a database, that is to be searched.

The system then prioritizes the I^{th} set of rules, determined during step 1204, in order to determine which rules of the I^{th} set of rules should be executed first (step 1208). Additionally, the system can prioritize the remaining rules in the I^{th} set of rules. Again, because computing resources are not infinite, those rules that are most likely to produce useful or interesting results are executed first.

After performing steps 1200 through 1206, the system executes the I^{th} query according to the I^{th} set of rules and within the I^{th} search space (step 1210). As a result, the system creates an I^{th} probability of an I^{th} inference (step 1212). As described above, the inference is a conclusion based on a comparison of facts within central database 400. The probability of the inference is the likelihood that the inference is true, or alternatively the probability that the inference is false. The I^{th} probability and the I^{th} inference need not be the same as the previous inference and probability in the recursion process, or one value could change but not the other. For example, as a result of the recursion process the I^{th} inference might be the same as the previous iteration in the recursion process, but the I^{th} probability could increase or decrease over the previous iteration in the recursion process. In contrast, the I^{th} inference can be completely different than the inference created in the previous iteration of the recursion process, with a probability that is either the same or different than the probability generated in the previous iteration of the recursion process.

Next, the system stores the I^{th} probability of the I^{th} inference as an additional datum in central database 400 (step 1214). Similarly, the system stores the I^{th} inference in central database 400 (step 1216), stores a categorization of the probability of the I^{th} inference in central database 400 (step 1218), stores the categorization of the I^{th} inference in the database (step 1220), stores the rules that were triggered in the I^{th} set of rules to generate the I^{th} inference (step 1222), and stores the I^{th} search space (step 1224). Additional information generated as a result of executing the query can also be stored at this time. All of the information stored in steps 1214 through 1224, and possibly in additional storage steps for additional information, can change how the system performs, how the system behaves, and can change the result during each iteration.

The process then follows two paths simultaneously. First, the system performs a recursion process (step 1226) in which steps 1200 through 1224 are continually performed, as described above. Second, the system determines whether additional data is received (step 1230).

Additionally, after each recursion, the system determines whether the recursion is complete (step 1228). The process of recursion is complete when a threshold is met. In one example, a threshold is a probability of an inference. When the probability of an inference decreases below a particular number, the recursion is complete and is made to stop. In another example, a threshold is a number of recursions. Once the given number of recursions is met, the process of recursion stops. Other thresholds can also be used. If the process of recursion is not complete, then recursion continues, beginning again with step 1200.

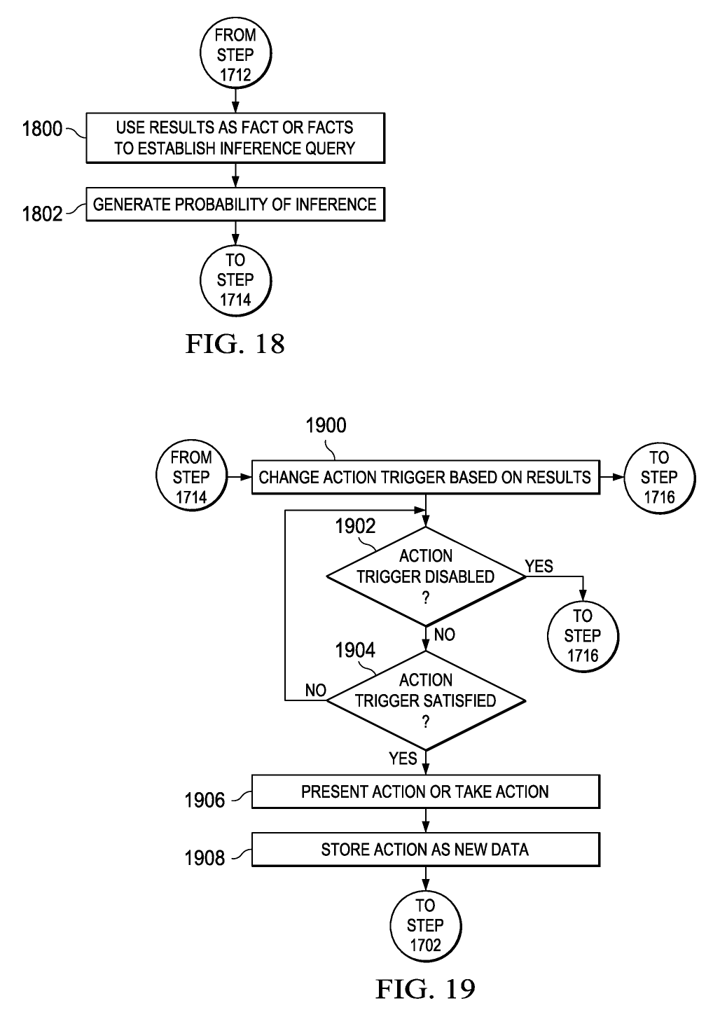

If the process of recursion is complete, then the process returns to step 1230. Thus, the system determines whether additional data is received at step 1230 during the recursion process in steps 1200 through 1224 and after the recursion process is completed at step 1228. If additional data is received, then the system conforms the additional data to the database (step 1232), as described with respect to FIG. 18. The system also associates metadata and a key with each additional datum (step 1224). A key uniquely identifies an individual datum. A key can be any unique identifier, such as a series of numbers, alphanumeric characters, other characters, or other methods of uniquely identifying objects.

If the system determines that additional data has not been received at step 1230, or after associating metadata and a key with each additional datum in step 1224, then the system determines whether to modify the recursion process (step 1236). Modification of the recursion process can include determining new sets of rules, expanding the search space, performing additional recursions after recursions were completed at step 1228, or continuing the recursion process.

In response to a positive determination to modify the recursion process at step 1236, the system again repeats the determination whether additional data has been received at step 1230 and also performs additional recursions from steps 1200 through 1224, as described with respect to step 1226.

Otherwise, in response to a negative determination to modify the recursion process at step 1236, the system determines whether to execute a new query (step 1238). The system can decide to execute a new query based on an inference derived at step 1212, or can execute a new query based on a prompt or entry by a user. If the system executes a new query, then the system can optionally continue recursion at step 1226, begin a new query recursion process at step 1200, or perform both simultaneously. Thus, multiple query recursion processes can occur at the same time. However, if no new query is to be executed at step 1238, then the process terminates.

FIG. 13 is a flowchart execution of an action trigger responsive to the occurrence of one or more factors, in accordance with an illustrative embodiment. The process shown in FIG. 13 can be implemented using inference engine 1000 and can be implemented in a single data processing system or across multiple data processing systems connected by one or more networks. Whether implemented in a single data processing system or across multiple data processing systems, taken together all data processing systems, hardware, software, and networks are together referred to as a system. The system implements the process.

The exemplary process shown in FIG. 13 is a part of the process shown in FIG. 12. In particular, after step 1212 of FIG. 12, the system executes an action trigger responsive to the occurrence of one or more factors (step 1300). An action trigger is some notification to a user to take a particular action or to investigate a fact or line of research. An action trigger is executed when the action trigger is created in response to a factor being satisfied.

A factor is any established condition. Examples of factors include, but are not limited to, a probability of the first inference exceeding a pre-selected value, a significance of the inference exceeding the same or different pre-selected value, a rate of change in the probability of the first inference exceeding the same or different pre-selected value, an amount of change in the probability of the first inference exceeding the same or different pre-selected value, and combinations thereof.

In one example, a factor is a pre-selected value of a probability. The pre-selected value of the probability is used as a condition for an action trigger. The pre-selected value can be established by a user or by the database, based on rules provided by the database or by the user. The pre-selected probability can be any number between zero percent and one hundred percent.

The exemplary action triggers described herein can be used for scientific research based on inference significance and/or probability. However, action triggers can be used with respect to any line of investigation or inquiry, including medical inquiries, criminal inquiries, historical inquiries, or other inquiries. Thus, action triggers provide for a system for passive information generation can be used to create interventional alerts. Such a system would be particularly useful in the medical research fields.

In a related example, the illustrative embodiments can be used to create an action trigger based on at least one of the biological system and the environmental factor. The action trigger can then be executed based on a parameter associated with at least one of the biological system and the environmental factor. In this example, the parameter can be any associated parameter of the biological system, such as size, complexity, composition, nature, chain of events, or others, and combinations thereof.

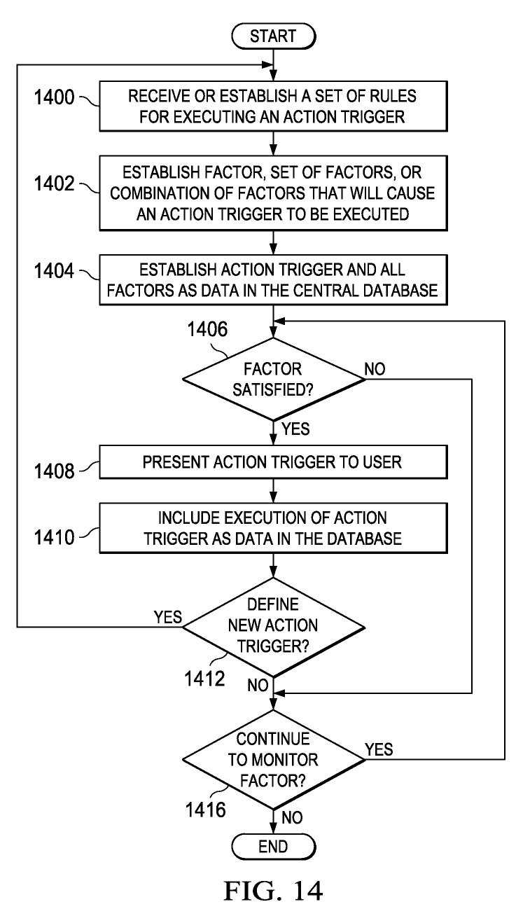

FIG. 14 is a flowchart illustrating an exemplary use of action triggers, in accordance with an illustrative embodiment. The process shown in FIG. 14 can be implemented using inference engine 1000 and can be implemented in a single data processing system or across multiple data processing systems connected by one or more networks. Whether implemented in a single data processing system or across multiple data processing systems, taken together all data processing systems, hardware, software, and networks are together referred to as a system. The system implements the process.

The process shown in FIG. 14 can be a stand-alone process. Additionally, the process shown in FIG. 14 can compose step 1300 of FIG. 13.

The process begins as the system receives or establishes a set of rules for executing an action trigger (step 1400). A user can also perform this step by inputting the set of rules into the database. The system then establishes a factor, a set of factors, or a combination of factors that will cause an action trigger to be executed (step 1402). A user can also perform this step by inputting the set of rules into the database. A factor can be any factor described with respect to FIG. 13. The system then establishes the action trigger and all factors as data in the central database (step 1404). Thus, the action trigger, factors, and all rules associated with the action trigger form part of the central database and can be used when establishing the probability of an inference according to the methods described elsewhere herein.

The system makes a determination whether a factor, set of factors, or combination of factors has been satisfied (step 1406). If the factor, set of factors, or combination of factors has not been satisfied, then the process proceeds to step 1414 for a determination whether continued monitoring should take place. If the factor, set of factors, or combination of factors have been satisfied at step 1406, then the system presents an action trigger to the user (step 1408). An action trigger can be an action trigger as described with respect to FIG. 13.

The system then includes the execution of the action trigger as an additional datum in the database (step 1410). Thus, all aspects of the process described in FIG. 14 are tracked and used as data in the central database.

The system then determines whether to define a new action trigger (step 1412). If a new action trigger is to be defined, then the process returns to step 1400 and the process repeats. However, if a new action trigger is not to be defined at step 1412, or if the factor, set of factors, or combination of factors have not been satisfied at step 1406, then the system determines whether to continue to monitor the factor, set of factors, or combination of factors (step 1414). If monitoring is to continue at step 1414, then the process returns to step 1406 and repeats. If monitoring is not to continue at step 1414, then the process terminates.

The method described with respect to FIG. 14 can be implemented in the form of a number of illustrative embodiments. For example, the action trigger can take the form of a message presented to a user. The message can be a request to a user to analyze one of a probability of the first inference and information related to the probability of the first inference. The message can also be a request to a user to take an action selected from the group including undertaking a particular line of research, investigating a particular fact, and other proposed actions.

In another illustrative embodiment, the action trigger can be an action other than presenting a message or other notification to a user. For example, an action trigger can take the form of one or more additional queries to create one or more probability of one or more additional inferences. In other examples, the action trigger relates to at least one of a security system, an information control system, a biological system, an environmental factor, and combinations thereof.

In another illustrative example, the action trigger is executed based on a parameter associated with one or more of the security system, the information control system, the biological system, and the environmental factor. In a specific illustrative example, the parameter can be one or more of the size, complexity, composition, nature, chain of events, and combinations thereof.

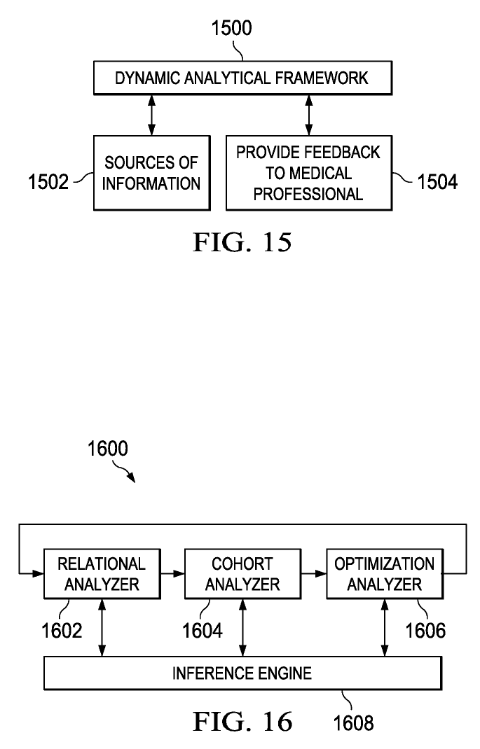

FIG. 15 is a block diagram of a system for providing medical information feedback to medical professionals, in accordance with an illustrative embodiment. The system shown in FIG. 15 can be implemented using one or more data processing systems, including but not limited to computing grids, server computers, client computers, network data processing system 100 in FIG. 1, and one or more data processing systems, such as data processing system 200 shown in FIG. 2. The system shown in FIG. 15 can be implemented using the system shown in FIG. 10. For example, dynamic analytical framework 1500 can be implemented using inference engine 1000 of FIG. 10. Likewise, sources of information 1502 can be any of sources A 1006 through source H 1020 in FIG. 10, or more or different sources. Means for providing feedback to medical professionals 1504 can be any means for communicating or presenting information, including screenshots on displays, emails, computers, personal digital assistants, cell phones, pagers, or one or combinations of multiple data processing systems.

Dynamic analytical framework 1500 receives and/or retrieves data from sources of information 1502. Preferably, each chunk of data is grabbed as soon as a chunk of data is available. Sources of information 1502 can be continuously updated by constantly searching public sources of additional information, such as publications, journal articles, research articles, patents, patent publications, reputable Websites, and possibly many, many additional sources of information. Sources of information 1502 can include data shared through web tool mash-ups or other tools; thus, hospitals and other medical institutions can directly share information and provide such information to sources of information 1502.

Dynamic analytical framework 1500 evaluates (edits and audits), cleanses (converts data format if needed), scores the chunks of data for reasonableness, relates received or retrieved data to existing data, establishes cohorts, performs clustering analysis, performs optimization algorithms, possibly establishes inferences based on queries, and can perform other functions, all on a real-time basis. Some of these functions are described with respect to FIG. 16.

When prompted, or possibly based on some action trigger, dynamic analytical framework 1500 provides feedback to means for providing feedback to medical professionals 1504. Means for providing feedback to medical professionals 1504 can be a screenshot, a report, a print-out, a verbal message, a code, a transmission, a prompt, or any other form of providing feedback useful to a medical professional.

Means for providing feedback to medical professionals 1504 can re-input information back into dynamic analytical framework 1500. Thus, answers and inferences generated by dynamic analytical framework 1500 are re-input back into dynamic analytical framework 1500 and/or sources of information 1502 as additional data that can affect the result of future queries or cause an action trigger to be satisfied. For example, an inference drawn that an epidemic is forming is re-input into dynamic analytical framework 1500, which could cause an action trigger to be satisfied so that professionals at the Center for Disease Control can take emergency action.

Thus, dynamic analytical framework 1500 provides a supporting architecture and a means for providing digesting truly vast amounts of very detailed data and aggregating such data in a manner that is useful to medical professionals. Dynamic analytical framework 1500 provides a method for incorporating the power of set analytics to create highly individualized treatment plans by establishing relationships among data and drawing conclusions based on all relevant data. Dynamic analytical framework 1500 can perform these actions on a real time basis, and further can optimize defined parameters to maximize perceived goals. This process is described more with respect to FIG. 16.

When the illustrative embodiments are implemented across broad medical provider systems, the aggregate results can be dramatic. Not only does patient health improve, but both the cost of health insurance for the patient and the cost of liability insurance for the medical professional are reduced because the associated payouts are reduced. As a result, the real cost of providing medical care, across an entire medical system, can be reduced; or, at a minimum, the rate of cost increase can be minimized.

In an illustrative embodiment, dynamic analytical framework 1500 can be manipulated to access or receive information from only selected ones of sources of information 1502, or to access or receive only selected data types from sources of information 1502. For example, a user can specify that dynamic analytical framework 1500 should not access or receive data from a particular source of information. On the other hand, a user can also specify that dynamic analytical framework 1500 should again access or receive that particular source of information, or should access or receive another source of information. This designation can be made contingent upon some action trigger. For example, should dynamic analytical framework 1500 receive information from a first source of information, dynamic analytical framework 1500 can then automatically begin or discontinue receiving or accessing information from a second source of information. However, the trigger can be any trigger or event.

In a specific example, some medical professionals do not trust, or have lower trust of, patient-reported data. Thus, a medical professional can instruct dynamic analytical framework 1500 to perform an analysis and/or inference without reference to patient-reported data in sources of information 1502. However, to see how the outcome changes with patient-reported data, the medical professional can re-run the analysis and/or inference with the patient-reported data. Continuing this example, the medical professional designates a trigger. The trigger is that, should a particular unlikely outcome arise, then dynamic analytical framework 1500 will discontinue receiving or accessing patient-reported data, discard any analysis performed to that point, and then re-perform the analysis without patient-reported data—all without consulting the medical professional. In this manner, the medical professional can control what information dynamic analytical framework 1500 uses when performing an analysis and/or generating an inference.

In another illustrative embodiment, data from selected ones of sources of information 1502 and/or types of data from sources of information 1502 can be given a certain weight. Dynamic analytical framework 1500 will then perform analyses or generate inferences taking into account the specified weighting.

For example, the medical professional can require dynamic analytical framework 1500 to give patient-related data a low weighting, such as 0.5, indicating that patient-related data should only be weighted 50%. In turn, the medical professional can give DNA tests performed on those patients a higher rating, such as 2.0, indicating that DNA test data should count as doubly weighted. The analysis and/or generated inferences from dynamic analytical framework 1500 can then be generated or re-generated as often as desired until a result is generated that the medical professional deems most appropriate.

This technique can be used to aid a medical professional in deriving a path to a known result. For example, dynamic analytical framework 1500 can be forced to arrive at a particular result, and then generate suggested weightings of sources of data or types of data in sources of information 1502 in order to determine which data or data types are most relevant. In this manner, dynamic analytical framework 1500 can be used to find causes and/or factors in arriving at a known result.

FIG. 16 is a block diagram of a dynamic analytical framework, in accordance with an illustrative embodiment. Dynamic analytical framework 1600 is a specific illustrative example of dynamic analytical framework 1500. Dynamic analytical framework 1600 can be implemented using one or more data processing systems, including but not limited to computing grids, server computers, client computers, network data processing system 100 in FIG. 1, and one or more data processing systems, such as data processing system 200 shown in FIG. 2.

Dynamic analytical framework 1600 includes relational analyzer 1602, cohort analyzer 1604, optimization analyzer 1606, and inference engine 1608. Each of these components can be implemented one or more data processing systems, including but not limited to computing grids, server computers, client computers, network data processing system 100 in FIG. 1, and one or more data processing systems, such as data processing system 200 shown in FIG. 2, and can take entirely hardware, entirely software embodiments, or a combination thereof. These components can be performed by the same devices or software programs. These components are described with respect to their functionality, not necessarily with respect to individual identities.

Relational analyzer 1602 establishes connections between received or acquired data and data already existing in sources of information, such as source of information 1502 in FIG. 15. The connections are based on possible relationships amongst the data. For example, patient information in an electronic medical record is related to a particular patient. However, the potential relationships are countless. For example, a particular electronic medical record could contain information that a patient has a particular disease and was treated with a particular treatment. The disease particular disease and the particular treatment are related to the patient and, additionally, the particular disease is related to the particular patient. Generally, electronic medical records, agglomerate patient information in electronic healthcare records, data in a data mart or warehouse, or other forms of information are, as they are received, related to existing data in sources of information 1502, such as source of information 1502 in FIG. 15.

In an illustrative embodiment, using metadata, a given relationship can be assigned additional information that describes the relationship. For example, a relationship can be qualified as to quality. For example, a relationship can be described as “strong,” such as in the case of a patient to a disease the patient has, be described as “tenuous,” such as in the case of a disease to a treatment of a distantly related disease, or be described according to any pre-defined manner. The quality of a relationship can affect how dynamic analytical framework 1600 clusters information, generates cohorts, and draws inferences.

In another example, a relationship can be qualified as to reliability. For example, research performed by an amateur medical provider may be, for whatever reason, qualified as “unreliable” whereas a conclusion drawn by a researcher at a major university may be qualified as “very reliable.” As with quality of a relationship, the reliability of a relationship can affect how dynamic analytical framework 1600 clusters information, generates cohorts, and draws inferences.

Relationships can be qualified along different or additional parameters, or combinations thereof. Examples of such parameters included, but are not limited to “cleanliness” of data (compatibility, integrity, etc.), “reasonability” of data (likelihood of being correct), age of data (recent, obsolete), timeliness of data (whether information related to the subject at issue would require too much time to be useful), or many other parameters.

Established relationships are stored, possibly as metadata associated with a given datum. After establishing these relationships, cohort analyzer 1604 relates patients to cohorts (sets) of patients using clustering, heuristics, or other algorithms. Again, a cohort is a group of individuals, machines, components, or modules identified by a set of one or more common characteristics.

For example, a patient has diabetes. Cohort analyzer 1604 relates the patient in a cohort comprising all patients that also have diabetes. Continuing this example, the patient has type I diabetes and is given insulin as a treatment. Cohort analyzer 1604 relates the patient to at least two additional cohorts, those patients having type I diabetes (a different cohort than all patients having diabetes) and those patients being treated with insulin. Cohort analyzer 1604 also relates information regarding the patient to additional cohorts, such as a cost of insulin (the cost the patient pays is a datum in a cohort of costs paid by all patients using insulin), a cost of medical professionals, side effects experienced by the patient, severity of the disease, and possibly many additional cohorts.

After relating patient information to cohorts, cohort analyzer 1604 clusters different cohorts according to the techniques described with respect to FIG. 3 through FIG. 9. Clustering is performed according to one or more defined parameters, such as treatment, outcome, cost, related diseases, patients with the same disease, and possibly many more. By measuring the Euclidean distance between different cohorts, a determination can be made about the strength of a deduction. For example, by clustering groups of patients having type I diabetes by severity, insulin dose, and outcome, the conclusion that a particular dose of insulin for a particular severity can be assessed to be “strong” or “weak.” This conclusion can be drawn by the medical professional based on presented cohort and clustered cohort data, but can also be performed using optimization analyzer 1606.

Optimization analyzer 1606 can perform optimization to maximize one or more parameters against one or more other parameters. For example, optimization analyzer 1606 can use mathematical optimization algorithms to establish a treatment plan with a highest probability of success against a lowest cost. Thus, simultaneously, the quality of healthcare improves, the probability of medical error decreases substantially, and the cost of providing the improved healthcare decreases. Alternatively, if cost is determined to be a lesser factor, then a treatment plan can be derived by performing a mathematical optimization algorithm to determine the highest probability of positive outcome against the lowest probability of negative outcome. In another example, all three of highest probability of positive outcome, lowest probability of negative outcome, and lowest cost can all be compared against each other in order to derive the optimal solution in view of all three parameters.

Continuing the example above, a medical professional desires to minimize costs to a particular patient having type I diabetes. The medical professional knows that the patient should be treated with insulin, but desires to minimize the cost of insulin prescriptions without harming the patient. Optimization analyzer 1606 can perform a mathematical optimization algorithm using the clustered cohorts to compare cost of doses of insulin against recorded benefits to patients with similar severity of type I diabetes at those corresponding doses. The goal of the optimization is to determine at what dose of insulin this particular patient will incur the least cost but gain the most benefit. Using this information, the doctor finds, in this particular case, that the patient can receive less insulin than the doctor's first guess. As a result, the patient pays less for prescriptions of insulin, but receives the needed benefit without endangering the patient.

In another example, the doctor finds that the patient should receive more insulin than the doctor's first guess. As a result, harm to the patient is minimized and the doctor avoided making a medical error using the illustrative embodiments.

Inference engine 1608 can operate with each of relational analyzer 1602, cohort analyzer 1604, and optimization analyzer 1606 to further improve the operation of dynamic analytical framework 1600. Inference engine 1608 is able to generate inferences, not previously known, based on a fact or query. Inference engine 1608 can be inference engine 1000 and can operate according to the methods and devices described with respect to FIG. 10 through FIG. 14.

Inference engine 1608 can be used to improve performance of relational analyzer 1602. New relationships among data can be made as new inferences are made. For example, based on a past query or past generated inference, a correlation is established that a single treatment can benefit two different, unrelated conditions. A specific example of this type of correlation is seen from the history of the drug sildenafil citrate (1-[4-ethoxy-3-(6,7-dihydro-1-methyl-7-oxo-3-propyl-1H-pyrazolo[4,3-d]pyrimidin-5-yl)phenylsulfonyl]-4-methylpiperazine citrate). This drug was commonly used to treat pulmonary arterial hypertension. However, an observation was made that, in some male patients, this drug also improved problems with impotence. As a result, this drug was subsequently marketed as a treatment for impotence. Not only were certain patients with this condition treatment, but the pharmaceutical companies that made this drug were able to profit greatly.

Inference engine 1608 can draw similar inferences by comparing cohorts and clusters of cohorts to draw inferences. Continuing the above example, inference engine 1608 could compare cohorts of patients given the drug sildenafil citrate with cohorts of different outcomes. Inference engine 1608 could draw the inference that those patients treated with sildenafil citrate experienced reduced pulmonary arterial hypertension and also experienced reduced problems with impotence. The correlation gives rise to a probability that sildenafil citrate could be used to treat both conditions. As a result, inference engine 1608 could take two actions: 1) alert a medical professional to the correlation and probability of causation, and 2) establish a new, direct relationship between sildenafil citrate and impotence. This new relationship is stored in relational analyzer 1602, and can subsequently be used by cohort analyzer 1604, optimization analyzer 1606, and inference engine 1608 itself to draw new conclusions and inferences.

Similarly, inference engine 1608 can be used to improve the performance of cohort analyzer 1604. Based on queries, facts, or past inferences, new inferences can be made regarding relationships amongst cohorts. Additionally, new inferences can be made that certain objects should be added to particular cohorts. Continuing the above example, sildenafil citrate could be added to the cohort of “treatments for impotence.” The relationship between the cohort “treatments for impotence” and the cohort “patients having impotence” is likewise changed by the inference that sildenafil citrate can be used to treat impotence.

Similarly, inference engine 1608 can be used to improve the performance of optimization analyzer 1606. Inferences drawn by inference engine 1608 can change the result of an optimization process based on new information. For example, in an hypothetically speaking only, had sildenafil citrate been a less expensive treatment for impotence than previously known treatments, then this fact would be taken into account by optimization analyzer 1606 in considering the best treatment option at lowest cost for a patient having impotence.

Still further, inferences generated by inference engine 1608 can be presented, by themselves, to medical professionals through, for example, means for providing feedback to medical professionals 1504 of FIG. 15. In this manner, attention can be drawn to a medical professional of new, possible treatment options for patients. Similarly, attention can be drawn to possible causes for medical conditions that were not previously considered by the medical professional. Such inferences can be ranked, changed, and annotated by the medical professional. Such inferences, including any annotations, are themselves stored in sources of information 1502. The process of data acquisition, query, relationship building, cohort building, cohort clustering, optimization, and inference can be repeated multiple times as desired to achieve a best possible inference or result. In this sense, dynamic analytical framework 1600 is capable of learning.

The illustrative embodiments can be further improved. For example, sources of information 1502 can include the details of a patient's insurance plan. As a result, optimization analyzer 1606 can maximize a cost/benefit treatment option for a particular patient according to the terms of that particular patient's insurance plan. Additionally, real-time negotiation can be performed between the patient's insurance provider and the medical provider to determine what benefit to provide to the patient for a particular condition.

Sources of information 1502 can also include details regarding a patient's lifestyle. For example, the fact that a patient exercises rigorously once a day can influence what treatment options are available to that patient.

Sources of information 1502 can take into account available medical resources at a local level or at a remote level. For example, treatment rankings can reflect locally available therapeutics versus specialized, remotely available therapeutics.

Sources of information 1502 can include data reflecting how time sensitive a situation or treatment is. Thus, for example, dynamic analytical framework 1500 will not recommend calling in a remote trauma surgeon to perform cardiopulmonary resuscitation when the patient requires emergency care.

Still further, information generated by dynamic analytical framework 1600 can be used to generate information for financial derivatives. These financial derivatives can be traded based on an overall cost to treat a group of patients having a certain condition, the overall cost to treat a particular patient, or many other possible derivatives.

In another illustrative example, the illustrative embodiments can be used to minimize false positives and false negatives. For, example, if a parameter along which cohorts are clustered are medical diagnoses, then parameters to optimize could be false positives versus false negatives. In other words, when the at least one parameter along which cohorts are clustered comprises a medical diagnosis, the second parameter can comprise false positive diagnoses, and the third parameter can comprise false negative diagnoses. Clusters of cohorts having those properties can then be analyzed further to determine which techniques are least likely to lead to false positives and false negatives.

When the illustrative embodiments are implemented across broad medical provider systems, the aggregate results can be dramatic. Not only does patient health improve, but both the cost of health insurance for the patient and the cost of liability insurance for the medical professional are reduced because the associated payouts are reduced. As a result, the real cost of providing medical care, across an entire medical system, can be reduced; or, at a minimum, the rate of cost increase can be minimized.

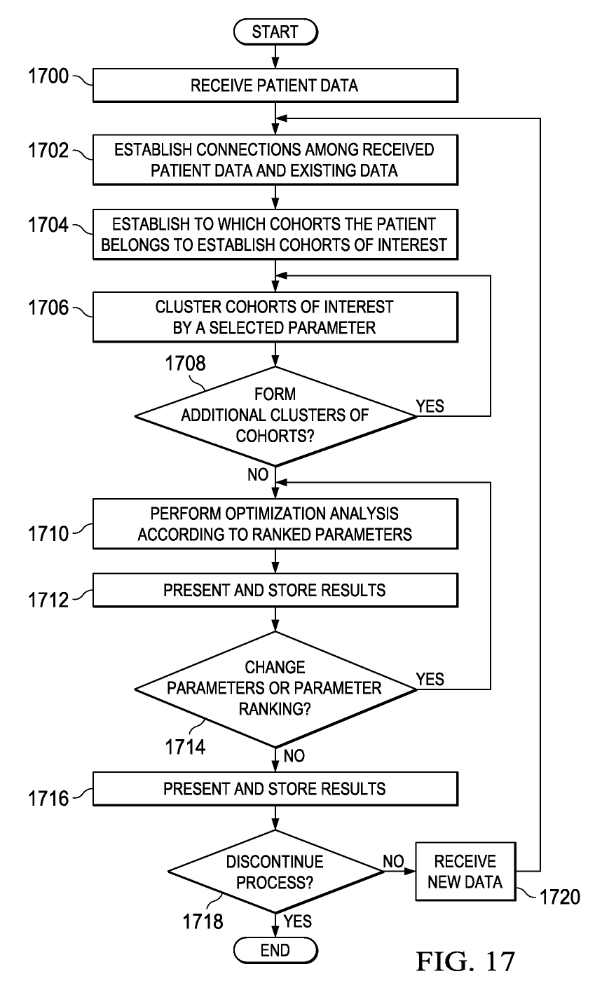

FIG. 17 is a flowchart of a process for presenting medical information feedback to medical professionals, in accordance with an illustrative embodiment. The process shown in FIG. 17 can be implemented using dynamic analytical framework 1500 in FIG. 15, dynamic analytical framework 1600 in FIG. 16, and possibly include the use of inference engine 1000 shown in FIG. 10. Thus, the process shown in FIG. 17 can be implemented using one or more data processing systems, including but not limited to computing grids, server computers, client computers, network data processing system 100 in FIG. 1, and one or more data processing systems, such as data processing system 200 shown in FIG. 2, and other devices as described with respect to FIG. 1 through FIG. 16. Together, devices and software for implementing the process shown in FIG. 17 can be referred-to as a “system.”

The process begins as the system receives patient data (step 1700). The system establishes connections among received patient data and existing data (step 1702). The system then establishes to which cohorts the patient belongs in order to establish “cohorts of interest” (step 1704). The system then clusters cohorts of interest according to a selected parameter (step 1706). The selected parameter can be any parameter described with respect to FIG. 16, such as but not limited to treatments, treatment effectiveness, patient characteristics, and medical conditions.

The system then determines whether to form additional clusters of cohorts (step 1708). If additional clusters of cohorts are to be formed, then the process returns to step 1706 and repeats.

Additional clusters of cohorts are not to be formed, then the system performs optimization analysis according to ranked parameters (step 1710). The ranked parameters include those parameters described with respect to FIG. 16, and include but are not limited to maximum likely benefit, minimum likely harm, and minimum cost. The system then both presents and stores the results (step 1712).

The system then determines whether to change parameters or parameter rankings (step 1714). A positive determination can be prompted by a medical professional user. For example, a medical professional may reject a result based on his or her professional opinion. A positive determination can also be prompted as a result of not achieving an answer that meets certain criteria or threshold previously input into the system. In any case, if a change in parameters or parameter rankings is to be made, then the system returns to step 1710 and repeats. Otherwise, the system presents and stores the results (step 1716).

The system then determines whether to discontinue the process. A positive determination in this regard can be made in response to medical professional user input that a satisfactory result has been achieved, or that no further processing will achieve a satisfactory result. A positive determination in this regard could also be made in response to a timeout condition, a technical problem in the system, or to a predetermined criteria or threshold.

In any case, if the system is to continue the process, then the system receives new data (step 1720). New data can include the results previously stored in step 1716. New data can include data newly acquired from other databases, such as any of the information sources described with respect to sources of information 1502 of FIG. 15, or data input by a medical professional user that is specifically related to the process at hand. The process then returns to step 1702 and repeats. However, if the process is to be discontinued at step 1718, then the process terminates.

FIG. 18 is a flowchart of a process for presenting medical information feedback to medical professionals, in accordance with an illustrative embodiment. The process shown in FIG. 18 is a particular example of using clustering set analytics together with an inference engine, such as inference engine 1000 in FIG. 10. The process shown in FIG. 18 can be implemented using dynamic analytical framework 1500 in FIG. 15, dynamic analytical framework 1600 in FIG. 16, and possibly include the use of inference engine 1000 shown in FIG. 10. Thus, the process shown in FIG. 18 can be implemented using one or more data processing systems, including but not limited to computing grids, server computers, client computers, network data processing system 100 in FIG. 1, and one or more data processing systems, such as data processing system 200 shown in FIG. 2, and other devices as described with respect to FIG. 1 through FIG. 16. Together, devices and software for implementing the process shown in FIG. 18 can be referred-to as a “system.”

The process shown in FIG. 18 is an extension of the process described with respect to FIG. 17. Thus, from step 1712 of FIG. 17, the system uses the stored results as a fact or facts to establish a frame of references for a query (step 1800). Based on this query, the system generates a probability of an inference (step 1802). The process of generating a probability of an inference, and examples thereof, are described with respect to FIG. 16 and FIGS. 12A and 12B. The process then proceeds to step 1714 of FIG. 17.

FIG. 19 is a flowchart of a process for presenting medical information feedback to medical professionals, in accordance with an illustrative embodiment. The process shown in FIG. 19 is a particular example of using clustering set analytics together with action triggers, as described in FIG. 14. The process shown in FIG. 19 can also incorporate the use of an inference engine, as described with respect to FIG. 18. The process shown in FIG. 19 can be implemented using dynamic analytical framework 1500 in FIG. 15, dynamic analytical framework 1600 in FIG. 16, and possibly include the use of inference engine 1000 shown in FIG. 10. Thus, the process shown in FIG. 19 can be implemented using one or more data processing systems, including but not limited to computing grids, server computers, client computers, network data processing system 100 in FIG. 1, and one or more data processing systems, such as data processing system 200 shown in FIG. 2, and other devices as described with respect to FIG. 1 through FIG. 16. Together, devices and software for implementing the process shown in FIG. 19 can be referred-to as a “system.”

The process shown in FIG. 19 is an extension of the process shown in FIG. 17. Thus, from step 1714 of FIG. 17, the system changes an action trigger based on the stored results (step 1900). The system then both proceeds to step 1716 of FIG. 17 and also determines whether the action trigger should be disabled (step 1902).

If the action trigger is to be disabled, then the action trigger is disabled and the process returns to step 1716. If not, then the system determines whether the action trigger has been satisfied (step 1904). If the action trigger has not been satisfied, then the process returns to step 1902 and repeats.

However, if the action trigger is satisfied, then the system presents the action or takes an action, as appropriate (step 1906). For example, the system, by itself, can take the action of issuing a notification to a particular user or set of users. In another example, the system presents information to a medical professional or reminds the medical professional to take an action.

The system then stores the action, or lack thereof, as new data in sources of information 1502 (step 1908). The process then returns to step 1702 of FIG. 17.

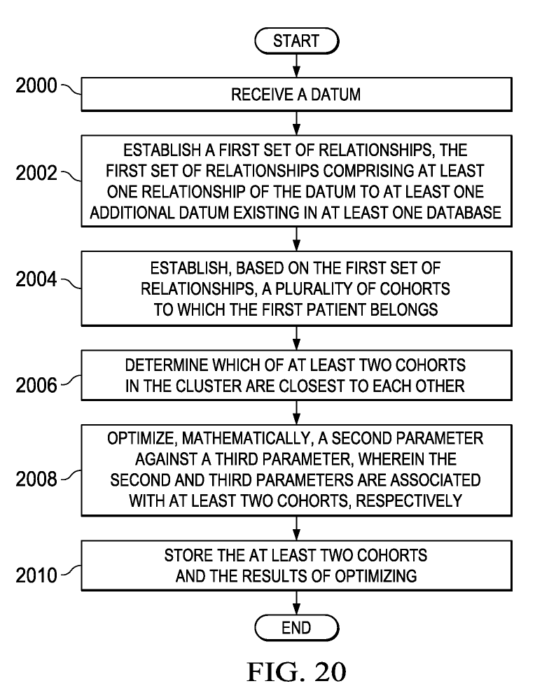

FIG. 20 is a flowchart of a process for presenting medical information feedback to medical professionals, in accordance with an illustrative embodiment. The process shown in FIG. 19 can be implemented using dynamic analytical framework 1500 in FIG. 15, dynamic analytical framework 1600 in FIG. 16, and possibly include the use of inference engine 1000 shown in FIG. 10. Thus, the process shown in FIG. 20 can be implemented using one or more data processing systems, including but not limited to computing grids, server computers, client computers, network data processing system 100 in FIG. 1, and one or more data processing systems, such as data processing system 200 shown in FIG. 2, and other devices as described with respect to FIG. 1 through FIG. 16. Together, devices and software for implementing the process shown in FIG. 20 can be referred-to as a “system.”

The process begins as a datum regarding a first patient is received (step 2000). The datum can be received by transmission to the system, or by the actively retrieving the datum. A first set of relationships is established, the first set of relationships comprising at least one relationship of the datum to at least one additional datum existing in at least one database (step 2002). A plurality of cohorts to which the first patient belongs is established based on the first set of relationships (step 2004). Ones of the plurality of cohorts contain corresponding first data regarding the first patient and corresponding second data regarding a corresponding set of additional information. The corresponding set of additional information is related to the corresponding first data. The plurality of cohorts is clustered according to at least one parameter, wherein a cluster of cohorts is formed. A determination is made of which of at least two cohorts in the cluster are closest to each other (step 2006). The at least two cohorts can be stored.

In another illustrative embodiment, a second parameter is optimized, mathematically, against a third parameter (step 2008). The second parameter is associated with a first one of the at least two cohorts. The third parameter is associated with a second one of the at least two cohorts. A result of optimizing can be stored, along with (optionally) the at least two cohorts (step 2010). The process terminates thereafter.

In another illustrative embodiment, establishing the plurality of cohorts further comprises establishing to what degree a patient belongs in the plurality of cohorts. In yet another illustrative embodiment the second parameter comprises treatments having a highest probability of success for the patient and the third parameter comprises corresponding costs of the treatments.

In another illustrative embodiment, the second parameter comprises treatments having a lowest probability of negative outcome and the second parameter comprises a highest probability of positive outcome. In yet another illustrative embodiment, the at least one parameter comprises a medical diagnosis, wherein the second parameter comprises false positive diagnoses, and wherein the third parameter comprises false negative diagnoses.

When the illustrative embodiments are implemented across broad medical provider systems, the aggregate results can be dramatic. Not only does patient health improve, but both the cost of health insurance for the patient and the cost of liability insurance for the medical professional are reduced because the associated payouts are reduced. As a result, the real cost of providing medical care, across an entire medical system, can be reduced; or, at a minimum, the rate of cost increase can be minimized.

The illustrative embodiments also provide a computer implemented method, apparatus, and computer usable program code for finding expert skills during times of chaos. A chaotic event is detected automatically or manually based on received information. The process of the illustrative embodiments is initiated in response to the detection of a potentially chaotic event. In general terms, management of the event begins from a single point or multiple points, based on the detection of a potentially chaotic situation. A determination is made as to what the required resources are for the situation.

Resources or expert resources are skills, expert skills, and resources required by individuals with skills to deal with the chaotic event. Resources include each expert individual with the necessary skills as well as transportation, communications, and materials to properly perform the task required by the expertise or skill of the individual. For example, heavy equipment operators may be needed as well as doctors. Heavy equipment operators may need bulldozers, backhoes, and transportation to the event location, and the doctors may require nurses, drugs, a sterile room, a communications center, emergency helicopters, and operating instruments.

The needed skills are optimized based on requirements and constraints for expert services, a potential skills pool, cohorts of a related set of skills, and enabling resources. Optimization is the process of finding a solution that is the best fit based on the available resources and specified constraints. The solution is skills and resources that are available and is recognized as the best solution among numerous alternatives because of the constraints, requirements, and other circumstances and criteria of the chaotic event. A cohort or unified group may be considered an entity rather than a group of individual skills, such as a fully functioning mobile army surgical hospital (MASH) unit.

The service requirements are transmitted to the management location for reconciliation of needed skills against available skills. Skills requirements and individuals and cohorts available for deployment are selected based on optimization of costs, time of arrival, utility value, capacity of transportation route, and value. Routes are how the resource is delivered. For example, in some cases, a route is an airplane. In another example, a route is a high-speed data line that allows a surgeon to remotely view an image. The process is continuously monitored and optimized based on feedback and changing situations. The execution of the plan is implemented iteratively to provide the necessary expert resources. The expert resources are deployed by decision makers to manage the chaotic event by effectively handling the circumstances, dangers, events, and problems caused by the chaotic event.

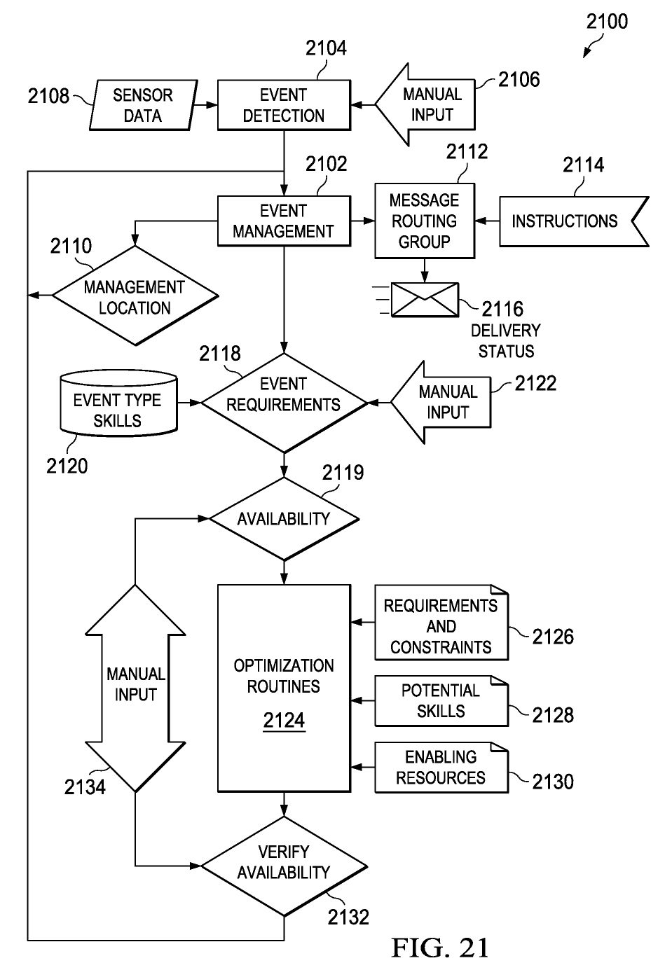

FIG. 21 is a block diagram for managing chaotic events in accordance with the illustrative embodiments. Event management system 2100 is a collection or network of computer programs, software components or modules, data processing systems, devices, and inputs used to manage expert skills for a chaotic event. Event management system 2100 includes all steps, decisions, and information that may be needed to deal with a chaotic event. Event management system 2100 may be a centralized computer program executed and accessible from a server, such as server 104 of FIG. 1 or a network of hardware and software components, such as network data processing system 200 of FIG. 2.

Event management system 2100 or portions of event management system 2100 may be stored in a databases or data structures, such as storage 108 of FIG. 1. Event management system 2100 may be accessed in person or by using a network, such as network 102 of FIG. 1. Event management system 2100 may be accessed by one or more users, decision makers, or event managers for managing the chaotic event. The user may enter information and receive information through an interface of event management system 2100. The information may be displayed to the user in text and graphics. Additionally, the user may be prompted to enter information and decisions to help the user walk through the management of the chaotic event. For example, event management system 2100 may walk a state governor through each step that should be taken for a sun flare that has crippled the state in a logical and effective sequence.

Event management system 2100 is used for information processing so that decisions may be more easily made based on incoming information that is both automatically sent and manually input. Event management system 2100 enables administrators, leaders, and other decision makers to make decisions in a structured and supported framework. In some cases, leaders may be so unprepared or shocked by the chaotic event that event management system 2100 may walk leaders through necessary steps. In this manner, event management system 2100 helps the leaders to take effective action quickly. Event management system 2100 intelligently interacts with decision makers providing a dynamic interface for prioritizing steps and a work flow for dealing with the chaotic event in a structured framework. The decisions may be based on policy and politics in addition to logistical information.

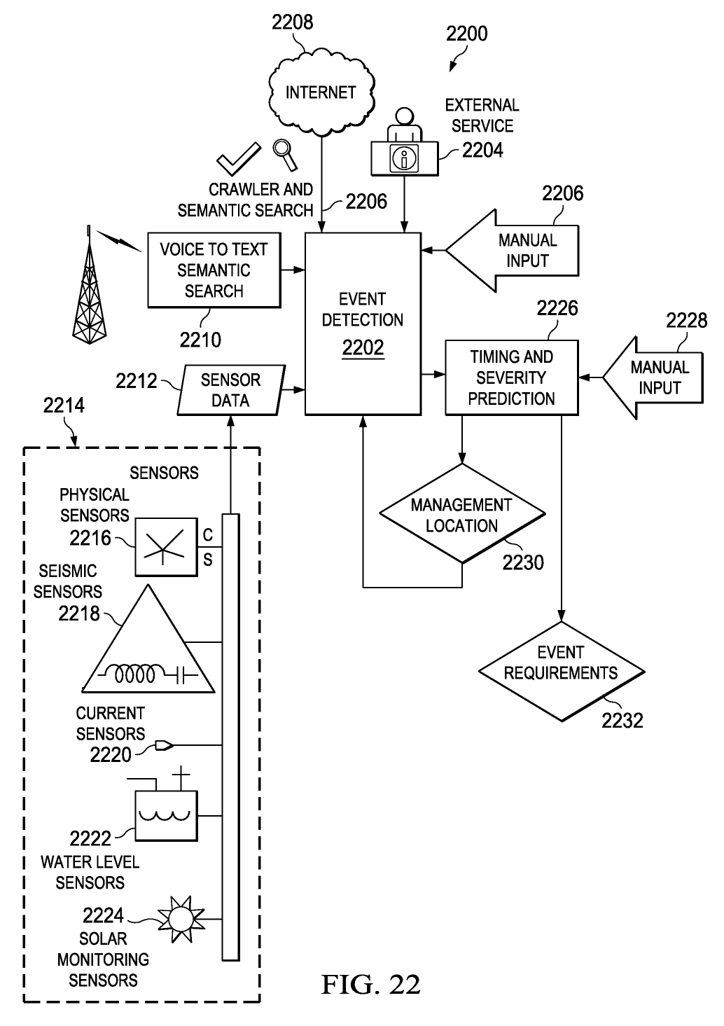

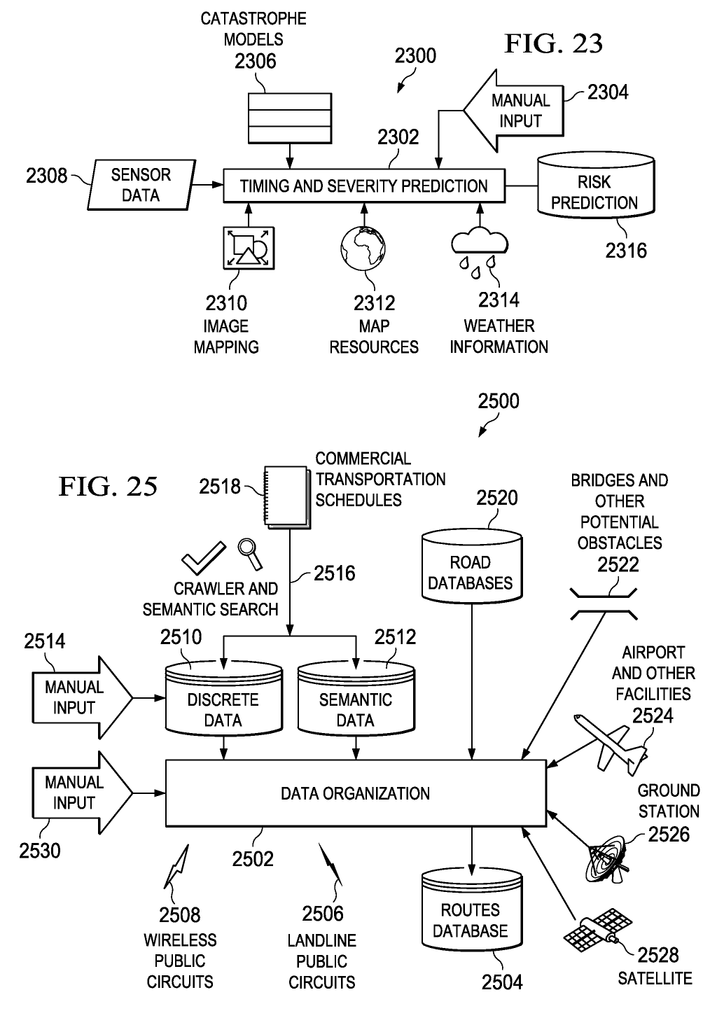

Event management system 2100 is managed by event management 2102. Event management 2102 begins the process of managing a chaotic event in response to event detection 2104 detecting the event. For example, if the chaotic event is a series of catastrophic tornadoes, event detection 2104 may become aware of the tornadoes through the national weather service. Alternatively, storm chasers may witness the series of tornadoes and report the event in the form of manual input 2106 to event detection 2104. Event detection 2104 may also be informed of the chaotic event by sensor data 2108. Sensor data is information from any number of sensors for detecting chaotic events including sensors for detecting wind, rain, seismic activity, radiation, and so forth. Event detection 2104 informs event management 2102 of the chaotic event occurrence and known details of severity so that preliminary estimates may be made. Event detection 2104 is further described in FIG. 22, and predicting severity of chaotic events is further described in FIG. 23 below.

Once event detection 2104 has informed event management 2102 of the location and occurrence of a chaotic event, event management 2102 works with management location 2110 to determine a suitable location for management of the event. Event detection 2104 sends a message to event management 2102. The message may specify any ascertained information, such as the time, focal point, geographic area, and severity of the chaotic event if known. For example, if event management 2102 is located on server 104 of FIG. 1 that has been flooded by torrential rains in Georgia, event management 2102 may be transferred to server 106 of FIG. 1, located in Texas. Management location 2110 allows the process of event management 2102 to occur from the best possible location. Event management 2102 may occur from multiple event management positions if there are multiple chaotic events simultaneously.

For example, the best possible location may be an external location out of the danger zone or affected area. Alternatively, the best possible location may be the location closest to the affected area that still has access to power, water, communications, and other similar utilities. Management location 2110 may maintain a heartbeat connection with a set of one or more event management positions for immediately transferring control to a specified event management component if the heartbeat connection is lost from an event management component in the affected area. The heartbeat signal should be an encrypted signal.

A heartbeat connect is a periodic message or signal informing other locations, components, modules, or people of the status of event management 2102. In another example, the chaotic event may be a federal disaster. A local management location 2110 may transfer control of event management 2102 to the headquarters of the supervising federal agency, such as Homeland Security or the Federal Aviation Administration (FAA). If event management 2102 is damaged or inaccessible, a redundant or alternative event management location automatically takes control. Additionally, event management 2102 may systematically make decisions regarding event management or transfer management location 2110 to a different location if event management 2102 does not receive instructions or feedback from decision makers or other individuals involved in management of the chaotic event.

For example, if a mayor providing user input and information from event management 2102 becomes unavailable, decisions regarding management may be made based on the best available information and alternatives. Additionally, management location 2110 may be transferred to a location where individuals are able and willing to provide user input and receive information from event management 2102.

In some cases, such as a large chemical release, leaders for corporations, organizations, and government entities may not have direct access to event management 2102. As a result, message routing group 2112 may be used to communicate instructions 2114 for the effective management of the chaotic event. Message routing group 2112 is the hardware and software system used to communicate instructions 2114 from event management 2102. Instructions 2114 may include directions, instructions, and orders for managing the response and other event-specific information.

Message routing group 2112 may keep track of whether instructions 2114 have been received by the intended party through the tracking of delivery status 2116. Delivery status 2116 indicates status information, such as if, when, how the message in instructions 2114 was delivered, and descriptions of any problems preventing delivery.

Event management 2102 passes information about the event to event requirements 2118. For example, event management 2102 may pass information regarding the severity of the chaotic event gleaned from manual input 2106 and sensor data 2108 to event requirements 2118. Event requirements 2118 determine which skills, resources, or other information is required for the chaotic event. Event requirements 2118 determine whether required skills and resources may be provided in person or remotely. For example, welders and trauma doctors may be required to be in person, but a pathologist may work via remote microscope cameras and a high-speed data connection.

Event requirements 2118 may be updated by event management 2102 as more information becomes available about the chaotic event. Event requirements 2118 may use event type skills 2120 to determine the skills needed based on the type of chaotic event. Event type skills 2120 is a collection of resources needed for each event type. For example, if a hurricane has damaged water-retaining facilities, such as reservoirs, levees, and canals, more civil engineers than normal may be required for the hurricane. Event type skills 2120 is preferably a database of skills stored in a database or memory, such as main memory 208 of FIG. 2 required for all possible chaotic events. For example, event type skills 2120 may specify the skills needed for a meltdown of a nuclear reactor including welders, waste disposal experts, nuclear engineers, paramedics, doctors, nuclear researchers, and so forth.

Event requirements 2118 may also receive information regarding required skills in the form of manual input 2122. Manual input 2122 may be received from authorized individuals close to the chaotic event, experts in the field, or based on other in-field or remote observations.

Information from event requirements 2118 is passed to availability 319. Availability 319 performs a preliminary determination of the skills and resources to determine available skills and resources. For example, experts with required skills may be called, emailed, or otherwise contacted to determine whether the expert is available, and if so, for how long and under what conditions or constraints. Individuals or organizations with manage, access, control, or possess resources are contacted to determine whether the resources may be used. Availability 319 may also rank potential skills and resources based on location, availability, proximity, cost, experience, and other relevant factors. Availability information is passed from availability 319 to optimization routines 2124.

Optimization routines 2124 uses information from availability 319, requirements and constraints 2126, potential skills 2128, and enabling resources 2130 to iteratively make suggestions regarding optimal skills and resources. Iterations are based particularly on event severity and event type. For example, optimization routines 2124 may be used once every six minutes at the onset of a chaotic event whereas after three months, the iterations may be updated once a day. Only skills and resources that may be available are considered by optimization routines 2124. Optimal skills and resources are derived based on elapsed time to arrive on-scene, proximity, capacity, importance, cost, time, and value. For example, optimal location for skills may be preferentially ordered by skill type and value or estimated time of arrival to the scene of the chaotic event.

Optimization routines 2124 is a process for maximizing an objective function by systematically choosing the values of real or integer variables from within an allowed set. The values used by optimization routines are values assigned to each skill, resource, route, and other factors that relate to delivery of the required skills and resources.

In one example, optimization routines 2124 may be described in the following way:

Given: a function ƒ: A→R from some set A

Sought: an element x₀ such that ƒ(x₀)≧ƒ(x) for all x in A

Typically, A is some subset of the Euclidean space Rⁿ, often specified by a set of constraints, equalities or inequalities that the members of A have to satisfy. For example, constraints may include capacity, time, and value. For example, the capacity of a truck and a helicopter are different as are a dial-up Internet connection and a cable Internet connection.

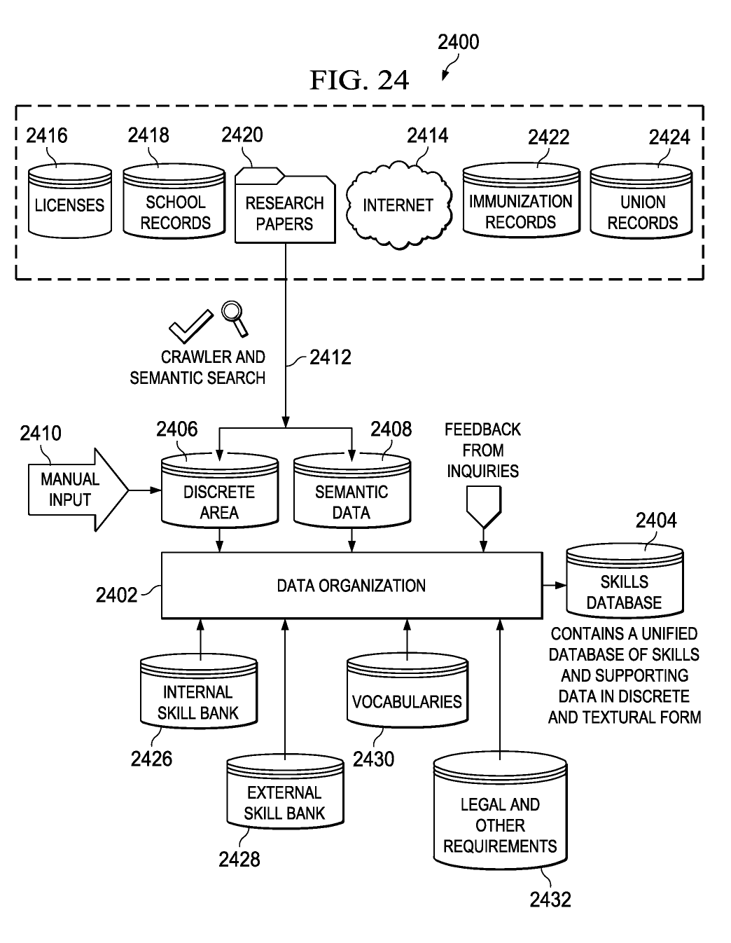

The elements of A are called feasible solutions. The function ƒ, that is maximized, is called an objective function or cost function. A feasible solution that maximizes the objective function is called an optimal solution and is the output of optimization routines 2124 in the form of optimized skills and resources. Optimal skills and resources are the resources that are the best solution to a problem based on constraints and requirements. For example, the problem or skill to be optimized may be that event managers need a doctor with a specialty in radiation sickness with three or more years experience in or around Texas with transportation to Dallas, Tex. that is available for the next two weeks. The optimal solution in this case may be a doctor that lives in Northern Dallas with the required experience and availability. The optimal solution for skills and resources is also optimized based on cost. If a bulldozer may be moved from two locations with similar restraints, the optimal solution is the cheapest solution. In other words, all other constraints being met, a lower cost resource is preferably to a higher cost resource. Aspects of optimization routines 2124 are further described in FIG. 24 for finding and organizing skills.

Requirements and constraints 2126 specify the requirements and constraints for expert services. Requirements and constraints 2126 may be established by local and federal law, organizational ethics, or other societal norms and policies. Similarly, requirements and constraints 2126 may be adjusted by persons in authority based on the needs and urgency of those needs. For example, during a biological disaster, there may be a requirement that only individuals immunized for small pox be allowed to provide services. Additionally, requirements and constraints 2126 may initially suggest that only medical doctors with three or more years of practice will be beneficial for the chaotic event. Requirements and constraints 2126 may be adjusted as needed, removed, or replaced with a new looser restraint. Decision makers should be informed about the binding constraints, such as license required.

Requirements and constraints 2126 may be dynamically adjusted based on conditions of the disaster. For example, if there is an extreme outbreak of small pox, constraints and requirements 2126 may specify that any doctor immunized for smallpox, regardless of experience, would be useful for dealing with the small pox outbreak. Requirements and constraints 2126 may be specified by governmental, public health, or business requirements.

Potential skills 2128 specify the potential expert skills of individuals that may be available. Potential skills 2128 may be generated based on commercial or governmental databases, job sites, research and papers, public licenses, or using a web crawler. For example, OmniFind produced by International Business Machines Corporation.

Enabling resources 2130 are the resources that enable qualified experts to perform the required tasks. Enabling resources 2130 may be manually generated by experts in each field or may be automatically generated based on past events. Enabling resources 2130 may be stored in a database or storage, such as 108 of FIG. 1. For example, if a bomb has partially destroyed a building, a structural engineer may require the use of a concrete X-ray machine to properly perform the tasks that may be required. In another example, a heart surgeon may instruct a general surgeon how to perform specialized procedures using high resolution web-cameras. As a result, enabling resources 2130 needs to have access to a data connection, including landlines or wireless communications at a specified bandwidth, and cameras, as well as a sterile location, medical equipment, and personnel to perform the procedure. In yet another example, doctors remotely servicing the outbreak of a virus may require email access to digital pictures taken by medical technicians in the area of the chaotic event.

Optimization routines 2124 computes the optimum mix of skills and resources. The answer will consist of the person and/or resources, transportation routes to the disaster site, time of availability, and the shadow price of substituting an alternate resource. Optimization routines 2124 specifies alternatives in case an optimum skill and resource is unavailable. As a result, the next most optimal skill and resource may be quickly contacted until the necessary skills and resources are found to manage the chaotic event.

Availability 319 and verify availability 2132 determines which experts and resources are available automatically or based on manual input 2134. In these examples, manual input 2134 may be received as each individual or group responsible for the expert or resource is contacted and terms of availability are checked. Manual inputs 2106, 2122, and 2134 may be submitted via phone, email, or other voice, text, or data recognition system. Alternatively, availability 319 and verify availability 2132 may use an automatic message system to contact each expert to determine availability. For example, using pre-collected email addresses for the experts, an automated messaging system may request availability information from experts with the desired skill set. For example, the Centers for Disease Control (CDC) may have a database of experts specifying personal information, for example, addresses, contact information, and inoculation history that may be used to contact required experts and professionals.

Verify availability 2132 determines whether the optimized skills and resources are available. Verify availability 2132 confirms that the skills and resources selected by event management 2102 to manage the chaotic event will in fact be available and may be relied on. For example, a surgical team that is selected by optimization routines 2124 as the best fit for a earthquake trauma team may need to be called on the phone to confirm that the surgical team may be flown to the earthquake site in exactly twenty four hours. Once verify availability 2132 has determined which experts and resources are available, that information is passed to event management 2102.

The process for updating event requirements 2118, availability 319, optimization routines 2124, and verify availability 2132 are repeated iteratively based on information regarding the chaotic event. For example, after an earthquake affecting the San Francisco area, event requirements 2118 may be updated every eight hours for two months until all of the required needs and skills have been acquired.

FIG. 22 is a block diagram for detecting chaotic events in accordance with the illustrative embodiments. Event detection system 2200 may be implemented in an event detection component, such as event detection 2104 of FIG. 21. Alternatively, event detection system 2200 may be part of an event management module, such as event management 2102 of FIG. 21. Event detection system 2200 is the system used to detect a potentially chaotic event. Event detection system 2200 may determine whether an event is real, and if so, whether the event is significant. For example, an undersea earthquake may or may not be a chaotic event based on location, size of the earthquake, and the potential for a tsunami.

Event detection 2202 functions using various techniques and processes to detect a potentially chaotic event. Event detection 2202 may become aware of the chaotic event through external service 2204. External service 2204 may be a government, business, or other organizational monitoring service. For example, external service 2204 may include the National Transportation Board, National Weather Service, National Hurricane Service, news wire services, Lloyds of London for loss of ships, the Bloomberg service, or Guy Carpenter insurance database, and other commercial information brokers.

Event detection 2202 may also receive manual input 2206, such as manual input 2106 of FIG. 21 as previously described. Manual input 2206 may also be used to verify whether a chaotic event has actually occurred. Crawler and semantic search 2206 may be used to access Internet 2208. Crawler and semantic search 2206 is a web crawler that searches publicly available portions of the Internet for keywords or other indications that a chaotic event has, is, or will occur. A web crawler is a program which browses Internet 2208 in a methodical, automated manner. For example, the web crawler may note email traffic, news stores, and other forms of data mining. False alarms are filtered out with heuristic rules and man-in-the-loop functions.

Similarly, voice to text semantic search 2210 may be used to identify that a chaotic event has taken place. Voice to text semantic search 2210 may use voice to text translations or voice recognition technologies to recognize phrases, keywords, or other indicators of a chaotic event. For example, transmissions across emergency broadcast channels or to emergency services may be analyzed by voice to text semantic search to identify that a reservoir has broken.

Event detection 2202 may also receive input from sensor data 2212. Sensor data 2212 is data, such as sensor data 2108 of FIG. 21. Sensor data 2212 may be received from sensors 2214 which may include physical sensors 2216, such as sensors that monitor gaps in bridges, seismic sensors 2218 for monitoring seismic activity, current sensors 2220 such as current sensors in utility lines for detecting electromagnetic pulses, water level sensors 2222, and solar monitoring sensors 2224 for indicating solar activity. Sensors 2214 are used to automatically pass sensor data 2212 indicating a chaotic event to event detection 2202. Sensors 2214 may also include monitors to indicate total loss of communications via internet or telephone to a given area, absolute volumes coming out of a particular area, spikes or communications jams, failures of cell phone towers, and other occurrences that indicate a chaotic event may have occurred.

Event detection 2202 outputs the event detection to timing and severity prediction 2226. Timing and severity prediction 2226 indicates the known timing and severity of the chaotic event or a predicted time and severity if the chaotic event is anticipated. Timing and severity prediction 2226 may receive information via manual input 2228. For example, a scientist measuring seismic activity may send data and visual information regarding the eruption of a volcano to indicate the severity of the event. Timing and severity prediction 2226 passes the information regarding time and severity to management location 2230. Management location 2230 is a location management module, such as management location 2110 of FIG. 21.

Timing and severity prediction 2226 passes information about the chaotic event to event requirements 2232. Timing and severity prediction 2226 predicts the severity of the chaotic event in addition to what skills and resources may be needed as well as the quantities of skills and resources. Event requirements 2232 is an event specific module, such as event requirements 2118 of FIG. 21. For example, if an unusually powerful solar flare is expected, communications and satellite coordinators and experts may be required to prevent effects of the solar flare or to recover from the effects after the event.

FIG. 23 is a block diagram for predicting severity of chaotic events in accordance with the illustrative embodiments. Timing and severity prediction system 2300 is a more detailed description of timing and severity prediction 2226 of FIG. 22. As previously described, timing and severity prediction 2302 receives manual input 2304.

Timing and severity prediction 2302 receives information from catastrophe models 2306. Catastrophe models 2306 are models of each possible chaotic event by region and the resulting affects and consequences of the chaotic event. Catastrophe models 2306 are preferably created by scientists and other experts before the occurrence of the chaotic event. For example, catastrophe models 2306 may model the effects of a category five hurricane striking South Carolina.

Sensor data 2308 is data, such as sensor data 2108 of FIG. 21. Additional information resources including, for example, image mapping 2310, map resources 2312 and weather information 2314 may be used by timing and severity prediction 2302 to determine the severity of the chaotic event. For example, image mapping 2310 may show the impact crater of a meteor. Map resources 2312 may be used to determine the number of buildings destroyed by a tornado. Weather information 2314 may be used to show whether a hurricane is ongoing or whether recovery efforts may begin. Weather information 2314 includes forecast models rather than raw data.

Timing and severity prediction 2302 uses all available information to make risk prediction 2316. Risk prediction 2316 specifies the risks associated with the chaotic event. For example, risk prediction 2316 may predict the dangers of a magnitude 7.4 earthquake in St. Louis before or after the earthquake has occurred.

FIG. 24 is a block diagram for finding and organizing skills for chaotic events in accordance with the illustrative embodiments. Organization system 2400 is a system that helps find expert skills or potentially available skills. Data is collected and organized by data organization 2402 to populate skills database 2404. Skills database 2404 is a unified database of skills and supporting data in discrete and textual form. For example, skills database 2404 may be implemented in event type skills 2120 of FIG. 21. The data organized by data organization 2402 may be physically instantiated or federated. In other words, the data may be actually copied into a database used by data organization 2402 or accessed through a query through a federated database. Federated databases may allow access to data that is not easily transferred but provides useful information.

Data organization 2402 organizes data from any number of sources as herein described. Data is received from discrete data 2406 and semantic data 2408. Discrete data 2406 is something that may be entered in a database, such as numbers or specific words. Semantic data has to be read in context. A pathology report may be broken up into discrete data 2406 including temperature, alive or dead. Manual input 2410 may be communicated to discrete data 2406. Data organization 2402 may use queries for discrete and semantic data to find necessary information.

Web crawler and semantic search referred to as crawler and semantic search 2412 may be used to gather data from any number of sources on Internet 2414 that are publicly available. Crawler and semantic search 2412 may be, Webfountain™, produced by International Business Machines Corporation or other similar products. For example, crawler and semantic search 2412 may search licenses 2416, school records 2418, research papers 2420, immunization records 2422, organizational records, and union records 2424. For example, crawler and semantic search 2412 may discover a large number of doctors that have graduated from medical school but do not have licenses in the state where the chaotic event occurred.

Data organization 2402 may further access internal skill bank 2426, external skill bank 2428, vocabularies 2430, and legal and other requirements 2432. Internal skill bank 2426 is a skill bank maintained by data organization 2402 in the event of a chaotic event. External skill bank 2428 may be a skill bank maintained by an outside organization or individual. External skill bank 2428 may be intended for emergency situations or may simply be a skill bank for organizing relevant skill sets in other business, government, or miscellaneous settings.

Feedback from inquiries 2434 specifies whether an individual is available and that another individual should be considered. For example, a drilling engineer may disclose unavailability to assist with a mine collapse.

FIG. 25 is a block diagram for finding and organizing routes for chaotic events in accordance with the illustrative embodiments. Route system 2500 may be implemented in optimization routine modules, such as optimization routines 2124 of FIG. 21. Route system 2500 is used to optimize available skills and resources based on distance, traveling time, capacity of a route, cost, and value as prioritized by decision makers from event management 2102 of FIG. 21. Route system 2500 performs optimizations based on questions which may include how far away the skills or resources are, how long the skills or resources take to get to the necessary location, and what the capacity is. For example, a truck may have a high capacity to move a team of surgeons if a road is available, but may take eight hours to get to a desired location. A helicopter may be used to quickly move a nuclear engineer regardless of road conditions. Route system 2500 may be used to perform optimizations based on event requirements 2118 of FIG. 21.

Data organization 2502 organizes information from various resources, and that information is passed to routes database 2504. Routes database 2504 is a unified database of physical and electronic routes including distances and capacity for expert skills and resources and limiting constraints. Constraints for routes may include availability, volume, cost, capacity, bytes, flights per hour, and trucks per day. Routes database 2504 may be used by availability components, such as availability 2132 of FIG. 21 to determine whether expert skills and resources are feasibly accessible by a route either physically or electronically even if they are available.

Data organization 2502 receives information from landline public circuits 2506. Landline public circuits 2506 may include communications lines, such as telephones, fiber-optics, data lines, and other physical means for transporting data and information. Data organization 2502 also receives information from wireless public circuits 2508 which may include wireless access points, cell phone communications, and other publicly available wireless networks.

Data is received from discrete data 2510 and semantic data 2512. Manual input 2514 may be communicated to discrete data 2510. Crawler and semantic search 2516 may be used to gather data from any number of sources. For example, crawler and semantic search 2516 may search commercial transportation schedules 2518 to find tractor trailers, busses, airlines, trains, boats, and other means of commercially available means of transporting people and resources.

Data organization 2502 may receive information from road databases 2520 for determining which roads may be used to access the geographic region of the chaotic event. Road databases 2520 may also specify which roads are accessible after the chaotic event. For example, after an earthquake in Salt Lake City, Interstate 15 may not be available because of overpass collapses.

Data organization 2502 may also receive information from bridges and other potential obstacles 2522. Airports and other facilities 2524 may provide additional information regarding airports and other similar facilities including status and capacity, such as train stations, docks, and other transportation hubs. For example, a data network may be available but only with low bandwidth access.

Data organization 2502 also receives information from ground station 2526. Ground station 2526 is a station located on the earth that is used for transmitting information to or receiving information from satellite 2528 or other earth orbiting communication devices. For example, information regarding ground station 2526 and satellite 2528 may specify capacity, capability, data rates, and availability. Ground station 2526 and satellite 2528 may be used by individuals with expert skills or resources to coordinate the response to the chaotic event. For example, in the event that medical images need to be sent from rural Idaho to New York City, ground station 2526 and satellite 2528 may need to have available bandwidth. Data organization 2502 may also receive information in the form of manual input 2530.

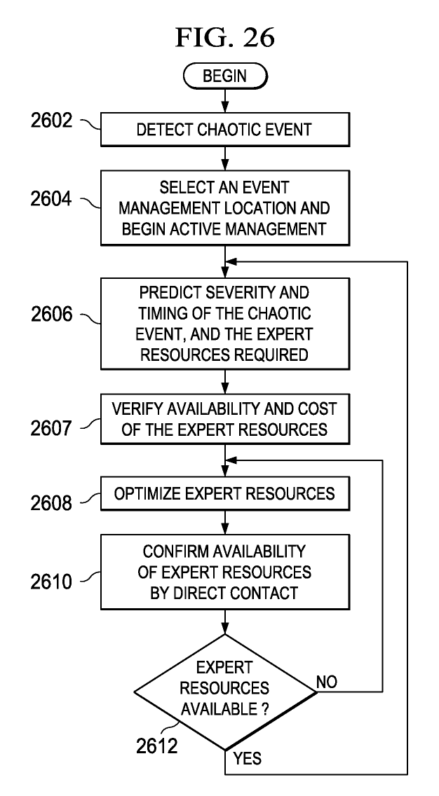

FIG. 26 is a flowchart for managing expert resources during times of chaos in accordance with the illustrative embodiments. The process of FIG. 26 may be implemented by an event management system, such as event management system 2100 of FIG. 21. In one example, the process of FIG. 26 is implemented by a program application that systematically walks one or more decision makers through the steps and decisions that need to occur to effectively manage the chaotic event. The program application systematically helps the decision make, develop, and implement a strategy for the chaotic event in a logical sequence based on predefined steps and priorities.

The process of FIG. 26 begins by detecting a chaotic event (step 2602). The event may be detected by a module, such as event detection 2104 of FIG. 21 and event detection system 2200 of FIG. 22.

Next, the process selects an event management location and begins active management (step 2604). Step 2604 may be performed by a module, such as event management 2102 of FIG. 21. The determination regarding event management location may be made based on feedback from a module, such as management location 2110 of FIG. 21. Active management in step 2604 may involve managing the situation by deploying personnel with expert skills and resources and coordinating relevant communication and recovery efforts.

Next, the process predicts severity and timing of the chaotic event, and the expert resources required (step 2606). Step 2606 may be implemented by a module, such as event requirements 2118 of FIG. 21 and timing and severity prediction system 2300 of FIG. 23. If the chaotic event is particularly severe, additional expert skills and resources may be required. Expert skills may be further determined using a module, such as organization system 2400 of FIG. 24. For example, if a tsunami occurs off the western coast of the United States, a large number of doctors and water contamination specialists may be required.

Next, the process verifies the availability and cost of the expert resources (step 807). The process of step 807 may be implemented by a module, such as availability 2119 of FIG. 21. Step 807 ensures that only potentially available resources are examined to save time, effort, and processing power.

Next, the process optimizes the expert resources (step 2608). The process of step 2608 may be performed by optimization routines, such as optimization routines 2124 of FIG. 21. The expert resources may be optimized based on factors, such as requirements and constraints 2126, potential skills 2128, and enabling resources 2130 of FIG. 21.

Next, the process confirms the availability of the expert resources by direct contact (step 2610). The process of step 2610 may be implemented by a module, such as verify availability 2132 of FIG. 21. Availability may be based on the schedule, time, and commitments of individual experts or groups of experts. Availability may also be determined based on routes for communicating and transporting skills and resources based on a system, such as route system 2500 of FIG. 25.

Next, the process determines whether the expert resources are available (step 2612). The determination of step 2612 may be based on transportation, cost, proximity, schedule, and time. For example, if the cost of flying a surgeon from Alaska to New York is impractical, the process may need to re-optimize the expert resources. If the expert resources are available, the process returns to step 2606. The process of steps 2606-2612 is repeated iteratively to optimize and re-optimize the active management of the response to the chaotic event in step 2604.

As a result, the management of the chaotic event is dynamic and adapts to changing circumstances. For example, if flooding from a hurricane washes out roads that were previously used to access staging areas, new routes for medical personnel and supplies needs to be determined in a step, such as step 2610. In addition, water contamination experts and water testing equipment may be required in greater numbers for a category five hurricane than for a category two hurricane.

If the process determines the expert sources are not available in step 2612, the process optimizes expert resources (step 2608). In other words, optimized expert resources are further re-optimized based on confirmed availability in step 2612. As a result, the decision makers or event managers may deploy the most appropriate resources to effectively manage each aspect of the chaotic event.

Thus, the illustrative embodiments provide a system, method and computer usable program code for finding expert services during a chaotic event. By detecting chaotic events as soon as possible and identifying the type of chaotic event, effective management of expert skills and resources may be quickly and efficiently managed. Information regarding potentially available skills and resources are used to determine how the chaotic event may be dealt with. By effectively optimizing expert skills and available routes based on availability, severity of the chaotic event, and other resulting factors, lives may be saved, and recovery efforts and the appropriate response may begin more effectively. The illustrative embodiments allow the best skills and resources available to be more easily found for addressing each aspect or problem caused by the chaotic event.

In another illustrative example, the methods and devices described herein can be used with respect to clinical applications. For example, the illustrative embodiments can be used to discover unobtrusive or difficult to detect relationships in disease state management. Thus, for example, the present invention can be used to track complex cases of cancer or multiply interacting diseases in individual patients. Additionally, patterns of a disease among potentially vast numbers of patients can be inferred in order to detect facts relating to one or more diseases. Furthermore, perhaps after analyzing patterns of a disease in a vast number of patients treated according to different treatment protocols, probabilities of success of various treatment plans can be inferred for a particular plan. Thus, another clinical application is determining a treatment plan for a particular patient.

In another clinical application, the methods and devices described herein can also be used to perform epidemic management and/or disease containment management. Thus, for example, the present invention can be used to monitor possible pandemics, such as the bird flu or possible terrorist activities, and generate probabilities of inferences of an explosion of an epidemic and the most likely sites of new infections.

In another clinical application, the methods and devices described herein can be used to perform quality control in hospitals or other medical facilities to continuously monitor outcomes. In particular, the methods and devices described herein can be used to monitor undesirable outcomes, such as hospital borne infections, re-operations, excess mortality, and unexpected transfers to intensive care or emergency departments.

In another clinical application, the methods and devices described herein can be used to perform quality analysis in hospitals or other medical facilities to determine the root causes of hospital borne infections. For example, wards, rooms, patient beds, staff members, operating suites, procedures, devices, drugs, or other systematic root causes, including multiple causalities can be identified using the methods and devices described herein.

In another clinical application, the methods and devices described herein can be used to determine a cause of a disease or a proximal cause of a disease. A cause is a direct cause of a disease. A proximal cause is some fact or condition that results in the direct cause or in a chain of additional proximal causes that leads to the direct cause of the disease. Thus, for example, a complex interplay of genetics, environmental factors, and lifestyle choices can be examined to determine a probability that one or more factors or combinations of factors causes a disease or other medical condition.

In another clinical application, the methods and devices described herein can be used for monitoring public health and public health information using public data sources. For example, the overall purchasing of over-the-counter drugs can be monitored. People are likely to self-medicate when they become sick, seeking medical attention only if they become very ill or the symptoms of an illness don't abate. Thus, a spike in purchase of over-the-counter drugs in a particular geographical location can indicate a possible public health problem that warrants additional investigation. Possible public health problems include natural epidemics, biological attacks, contaminated water supplies, contaminated food supplies, and other problems. Additional information, such as specific locations of excessive over-the-counter drug purchases, time information, and other information can be used to narrow the cause of a public health problem. Thus, public health problems can be quickly identified and isolated using the mechanisms described herein.

A summary of clinical applications, therefore includes determining a cause of a disease, determining a proximal cause of a disease, determining a cause of a medical condition, determining a proximal cause of a medical condition, disease state management, medical condition management, determining a pattern of at least one disease in a plurality of patients, determining a pattern of at least one medical condition in a plurality of patients, selecting a treatment plan for a particular patient, determining a genetic factor in relation to a disease, determining a genetic factor in relation to a medical condition, epidemic management, disease containment management, quality control in a medical facility, quality analysis in the medical facility, and monitoring public health. A medical condition is any condition from which a human or animal can suffer which is undesirable but which is not classified as a disease.

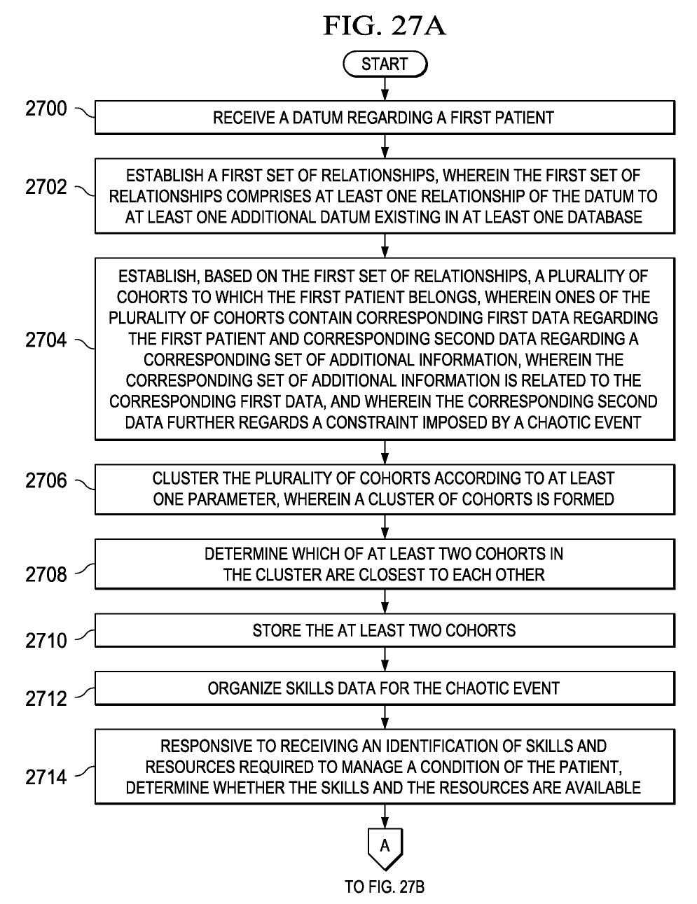

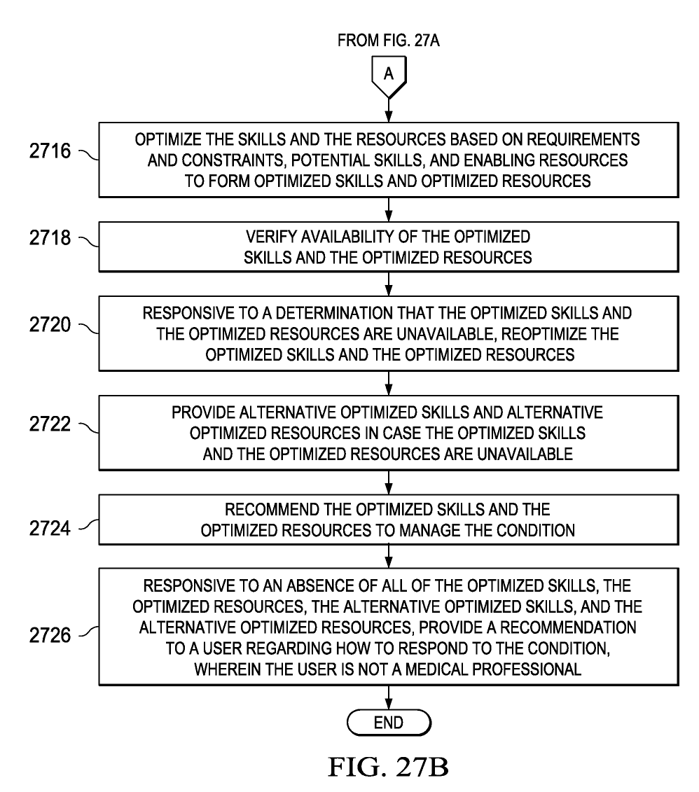

FIGS. 27A and 27B are flowcharts illustrating a method of managing, during a chaotic event, a condition of a patient, in accordance with the illustrative embodiments. The process of FIGS. 27A and 27B may be implemented by an event management system, such as event management system 2100 of FIG. 21. In one example, the process of FIGS. 27A and 27B are implemented by a program application that systematically walks one or more decision makers through the steps and decisions that need to occur to effectively manage the chaotic event. The program application systematically helps the decision make, develop, and implement a strategy for the chaotic event in a logical sequence based on predefined steps and priorities. Additionally, the process shown in FIGS. 27A and 27B can be implemented using dynamic analytical framework 1500 in FIG. 15, dynamic analytical framework 1600 in FIG. 16, and possibly include the use of inference engine 1000 shown in FIG. 10. Thus, the process shown in FIGS. 27A and 27B can be implemented using one or more data processing systems, including but not limited to computing grids, server computers, client computers, network data processing system 100 in FIG. 1, and one or more data processing systems, such as data processing system 200 shown in FIG. 2, and other devices as described with respect to FIG. 1 through FIG. 16. Together, devices and software for implementing the process shown in FIGS. 27A and 27B can be referred-to as a “system.”

The process begins as the system receives a datum regarding a first patient (step 2700). The system then establishes a first set of relationships, wherein the first set of relationships comprises at least one relationship of the datum to at least one additional datum existing in at least one database (step 2702). The system also establishes, based on the first set of relationships, a plurality of cohorts to which the first patient belongs, wherein ones of the plurality of cohorts contain corresponding first data regarding the first patient and corresponding second data regarding a corresponding set of additional information, wherein the corresponding set of additional information is related to the corresponding first data, and wherein the corresponding second data further regards a constraint imposed by a chaotic event (step 2704).

Next, the system clusters the plurality of cohorts according to at least one parameter, wherein a cluster of cohorts is formed (step 2706). The system then determines which of at least two cohorts in the cluster are closest to each other (step 2708). Optionally, the system stores the at least two cohorts (step 2710).

The method can be expanded in that the system can organize skills data for the chaotic event (step 2712). Responsive to receiving an identification of skills and resources required to manage a condition of the patient, the system determines whether the skills and the resources are available (step 2714).

The system then optimizes the skills and the resources based on requirements and constraints, potential skills, and enabling resources to form optimized skills and optimized resources (step 2716). To ensure quality, the system verifies availability of the optimized skills and the optimized resources (step 2718). Responsive to a determination that the optimized skills and the optimized resources are unavailable, re-optimize the optimized skills and the optimized resources (step 2720).

The system can then provide alternative optimized skills and alternative optimized resources in case the optimized skills and the optimized resources are unavailable (step 2722). The system then recommends the optimized skills and the optimized resources to manage the condition (step 2724). In the case where a user is not a medical professional, then the system can, responsive to an absence of all of the optimized skills, the optimized resources, the alternative optimized skills, and the alternative optimized resources, provide a recommendation to a user regarding how to respond to the condition (step 2726). The process terminates thereafter.

The illustrative embodiments described herein provide a computer implemented method for collecting data required to formulate constraints, including uncertainties and lack of information, include uncertainty in multiple dimensions, and then perform a mathematical optimization to determine best available treatment plans subject to the constraints. The proposed treatment plans are subject to human review, and re-optimization can be performed according to user input, changing events, or newly available information. The illustrative embodiments build an open framework capable of incorporating technologies in the fields of heuristics, ontology, and other areas in the data processing arts.

Thus, the optimization process can be run on a continuous basis to incorporate changes in the situation and feedback on treatments. Thus, the illustrative embodiments described herein are particularly useful in chaotic situations and in situations subject to severe constraints. For example, the illustrative embodiments could be used to deliver optimized healthcare to individual patients or groups of patients after a major hurricane, major earthquake, or terrorist event. Likewise, the illustrative embodiments could be used to recommend healthcare to injured or sick astronauts with extremely limited access to healthcare facilities, or even to travelers stuck on long airline flights or on maritime vessels.

The database of the illustrative embodiments is active, in the sense that the database can actively search for information in different and unrelated databases according to generated inferences and/or rules established by users or the database itself. The databases of the illustrative embodiments can track actions and learn from responses to improve the accuracy of inferences and to improve trends of the inference generation processes. In this sense, the database of the illustrative embodiments is an intelligent database.

Note that the database of the illustrative embodiments is modular and can incorporate additional technologies. For example, the database can use techniques regarding cohorts and clustering analysis described in U.S. Ser. No. 11/542,397, filed Oct. 3, 2006, and in U.S. Ser. No. 12/121,947, filed May 16, 2008. Additionally, the database of the illustrative embodiments can use other, off-the-shelf, products in the course of its operation. For example, the database of the illustrative embodiments can use OMNIFIND®, available from International Business Machines Corporation of Armonk, N.Y.—or other semantic tools—to harvest data from unstructured sources, such as police reports, blogs, essays, emails, and many other sources of data. The database of the illustrative embodiments can use other tools, as well. For example, the database of the illustrative embodiments can use historical seed cohorts to build clustered cohorts with similar values. In yet another example, the database of the illustrative embodiments can work with automatic translation engines to further add to the corpus of data. In still another example, the database of the illustrative embodiments can use other databases or tools to generate likely or suggested medical diagnoses for potentially mentally ill dangerous person. The database of the illustrative embodiments can also support context sensitive annotation of data.

The illustrative embodiments attempt to incorporate as much data as possible into the analytical framework. The more data that is available, the more likely that an optimal solution can be achieved. For example, the analytical framework of the illustrative embodiments can take into account capacity and dependability of networks and other communications links to and from the location of the chaotic event or problem situation. The analytical framework of the illustrative embodiments can also take into account the knowledge level and physical and mental states of available responders. Thus, for example, the illustrative embodiments can provide instructions to non-medical personnel to assist in providing aid to sick or injured persons. The analytical framework of the illustrative embodiments can also take into account inventories of available medical and other supplies, estimated time of arrival of responders or material, weather forecasts, dynamically changing forecasts of combat conditions, and many, many other possible facts. In this way, the illustrative embodiments can provide a recommendation that is mathematically optimized based on the most amount of data available.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method comprising:
receiving a datum regarding a first patient;
establishing a first set of relationships, wherein the first set of relationships comprises at least one relationship of the datum to at least one additional datum existing in at least one database;
establishing, based on the first set of relationships, a plurality of cohorts to which the first patient belongs, wherein ones of the plurality of cohorts contain corresponding first data regarding the first patient and corresponding second data regarding a corresponding set of additional information, wherein the corresponding set of additional information is related to the corresponding first data, and wherein the corresponding second data further regards a constraint imposed by a chaotic event;
clustering the plurality of cohorts according to at least one parameter, wherein a cluster of cohorts is formed;
determining which of at least two cohorts in the cluster are closest to each other; and
storing the at least two cohorts.

2. The computer implemented method of claim 1 further comprising:
organizing skills data for the chaotic event;
responsive to receiving an identification of skills and resources required to manage a condition of the patient, determining whether the skills and the resources are available;
optimizing the skills and the resources based on requirements and constraints, potential skills, and enabling resources to form optimized skills and optimized resources;
verifying availability of the optimized skills and the optimized resources; and
responsive to a determination that the optimized skills and the optimized resources are unavailable, re-optimizing the optimized skills and the optimized resources.

3. The computer implemented method of claim 2 further comprising:
providing alternative optimized skills and alternative optimized resources in case the optimized skills and the optimized resources are unavailable; and
recommending the optimized skills and the optimized resources to manage the condition.

4. The computer implemented method of claim 3 further comprising:
responsive to an absence of all of the optimized skills, the optimized resources, the alternative optimized skills, and the alternative optimized resources, providing a recommendation to a user regarding how to respond to the condition, wherein the user is not a medical professional.

5. The computer implemented method of claim 1 further comprising:
optimizing, mathematically, a second parameter against a third parameter, wherein the second parameter is associated with a first one of the at least two cohorts, and wherein the third parameter is associated with a second one of the at least two cohorts; and
storing a result of optimizing.

6. The computer implemented method of claim 1 wherein establishing the plurality of cohorts further comprises establishing to what degree the patient belongs in corresponding ones of the plurality of cohorts.

7. The computer implemented method of claim 5 wherein the second parameter comprises treatments having a highest probability of success for the patient and the third parameter comprises corresponding costs of the treatments.

8. The computer implemented method of claim 5 wherein the second parameter comprises treatments having a lowest probability of negative outcome and the third parameter comprises a highest probability of positive outcome.

9. The computer implemented method of claim 5 wherein the at least one parameter comprises a medical diagnosis, wherein the second parameter comprises false positive diagnoses, and wherein the third parameter comprises false negative diagnoses.

10. A computer program product comprising:
a computer readable medium storing instructions for performing a computer implemented method, the instructions comprising:
instructions for receiving a datum regarding a first patient;
instructions for establishing a first set of relationships, wherein the first set of relationships comprises at least one relationship of the datum to at least one additional datum existing in at least one database;
instructions for establishing, based on the first set of relationships, a plurality of cohorts to which the first patient belongs, wherein ones of the plurality of cohorts contain corresponding first data regarding the first patient and corresponding second data regarding a corresponding set of additional information, wherein the corresponding set of additional information is related to the corresponding first data, and wherein the corresponding second data further regards a constraint imposed by a chaotic event;
instructions for clustering the plurality of cohorts according to at least one parameter, wherein a cluster of cohorts is formed; and
instructions for determining which of at least two cohorts in the cluster are closest to each other.

11. The computer program product of claim 10 further comprising:
instructions for organizing skills data for the chaotic event;
instructions for, responsive to receiving an identification of skills and resources required to manage a condition of the patient, determining whether the skills and the resources are available;
instructions for optimizing the skills and the resources based on requirements and constraints, potential skills, and enabling resources to form optimized skills and optimized resources;
instructions for verifying availability of the optimized skills and the optimized resources; and
instructions for, responsive to a determination that the optimized skills and the optimized resources are unavailable, re-optimizing the optimized skills and the optimized resources.

12. The computer program product of claim 11 further comprising:
instructions for providing alternative optimized skills and alternative optimized resources in case the optimized skills and the optimized resources are unavailable; and
instructions for recommending the optimized skills and the optimized resources to manage the condition.

13. The computer program product of claim 12 further comprising:
instructions for, responsive to an absence of all of the optimized skills, the optimized resources, the alternative optimized skills, and the alternative optimized resources, providing a recommendation to a user regarding how to respond to the condition, wherein the user is not a medical professional.

14. The computer program product of claim 10 further comprising:
instructions for optimizing, mathematically, a second parameter against a third parameter, wherein the second parameter is associated with a first one of the at least two cohorts, and wherein the third parameter is associated with a second one of the at least two cohorts; and
instructions for storing a result of optimizing.

15. A data processing system comprising:
a bus;
a processor connected to the bus;
a memory connected to the bus, wherein the memory contains a set of instructions for performing a computer implemented method, and wherein the processor is operable to execute the set of instructions to:
receive a datum regarding a first patient;
establish a first set of relationships, wherein the first set of relationships comprises at least one relationship of the datum to at least one additional datum existing in at least one database;
establish, based on the first set of relationships, a plurality of cohorts to which the first patient belongs, wherein ones of the plurality of cohorts contain corresponding first data regarding the first patient and corresponding second data regarding a corresponding set of additional information, wherein the corresponding set of additional information is related to the corresponding first data, and wherein the corresponding second data further regards a constraint imposed by a chaotic event;
cluster the plurality of cohorts according to at least one parameter, wherein a cluster of cohorts is formed; and
determine which of at least two cohorts in the cluster are closest to each other.

16. The data processing system of claim 15 wherein the processor is operable to execute the set of instructions to:
organize skills data for the chaotic event;
responsive to receiving an identification of skills and resources required to manage a condition of the patient, determine whether the skills and the resources are available;
optimize the skills and the resources based on requirements and constraints, potential skills, and enabling resources to form optimized skills and optimized resources;
verify availability of the optimized skills and the optimized resources; and
responsive to a determination that the optimized skills and the optimized resources are unavailable, re-optimize the optimized skills and the optimized resources.

17. The data processing system of claim 16 wherein the processor is operable to execute the set of instructions to:
provide alternative optimized skills and alternative optimized resources in case the optimized skills and the optimized resources are unavailable; and
recommend the optimized skills and the optimized resources to manage the condition.

18. The data processing system of claim 17 wherein the processor is operable to execute the set of instructions to:
responsive to an absence of all of the optimized skills, the optimized resources, the alternative optimized skills, and the alternative optimized resources, provide a recommendation to a user regarding how to respond to the condition, wherein the user is not a medical professional.

19. The data processing system of claim 15 wherein the processor is operable to execute the set of instructions to:
optimize, mathematically, a second parameter against a third parameter, wherein the second parameter is associated with a first one of the at least two cohorts, and wherein the third parameter is associated with a second one of the at least two cohorts; and
store a result of optimizing.
